(19) United States
(12) Patent Application Publication
(10) Pub. No.: US 2025/0234357 A1
(43) Pub. Date: Jul. 17, 2025

(54) PDSCH TRANSMISSION METHOD AND APPARATUS FOR DATA COLLECTION IN WIRELESS COMMUNICATION SYSTEM

(71) Applicant: SAMSUNG ELECTRONICS CO., LTD., Suwon-si (KR)

(72) Inventors: Sooeun SONG, Suwon-si (KR); Suhwook KIM, Suwon-si (KR); Deokhui LEE, Suwon-si (KR); Jaehong YI, Suwon-si (KR); Changsung LEE, Suwon-si (KR); Jeonghyeon JANG, Suwon-si (KR)

(21) Appl. No.: 19/016,893

(22) Filed: Jan. 10, 2025

(30) Foreign Application Priority Data
Jan. 11, 2024 (KR) 10-2024-0004649

(51) Int. Cl. H04W 72/232; H04W 24/02

(52) U.S. Cl. CPC H04W 72/232; H04W 24/02

(57) ABSTRACT

The disclosure relates to a 6G communication system for achieving high data transfer rate and ultra-low latency after 4G and 5G communication systems. In a method performed by a terminal, the terminal receives, from a base station, a message including information for receiving a preconfigured physical downlink shared channel (PDSCH), and receives the preconfigured PDSCH from the base station, based on the information for receiving the preconfigured PDSCH. In addition, the terminal performs decoding on the received preconfigured PDSCH, and transmits information on a result of the decoding to the base station. The preconfigured PDSCH may be used to collect information for improving a quality of data transmission or reception. Also, the preconfigured PDSCH may be received using a time when a PDSCH for data reception is not received.

### CROSS-REFERENCE TO RELATED APPLICATION

This application is based on and claims priority under 35 U.S.C. § 119 to Korean Patent Application No. 10-2024-0004649, filed on Jan. 11, 2024, in the Korean Intellectual Property Office, the disclosures of which are herein incorporated by reference in their entireties.

### BACKGROUND

### 1. Field

The disclosure relates to a method and apparatus for data collection for channel measurement or artificial intelligence (AI) technology in a wireless communication system. More specifically, the disclosure relates to a method for collecting data through additional physical downlink shared channel (PDSCH) transmission by utilizing spare resources at a base station.

### 2. Description of Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 sec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### SUMMARY

According to embodiments of the present disclosure, a terminal in a wireless communication system is provided, the terminal comprising: a transceiver; and at least one processor coupled with the transceiver and configured to: receive, from a base station, a first message comprises first information for receiving a preconfigured physical downlink shared channel (PDSCH), based on the first information, receive, from the base station, the preconfigured PDSCH, perform decoding on the received preconfigured PDSCH, and transmit, to the base station, second information on a result of the decoding, wherein the preconfigured PDSCH is used to collect third information for improving a quality of data transmission or reception, and wherein the at least one processor is further configured to receive the preconfigured PDSCH based on a time when a PDSCH for data reception is not received.

According to embodiments of the present disclosure, the at least one processor is further configured to transmit, to the base station, a second message requesting the preconfigured PDSCH, and wherein the second message comprises a condition associated with the preconfigured PDSCH.

According to embodiments of the present disclosure, the first information comprises at least one of an indicator indicating that the preconfigured PDSCH is used to collect the third information or an indicator associated with the preconfigured PDSCH.

According to embodiments of the present disclosure, the first information comprises at least one of an indicator indicating whether to retransmit the preconfigured PDSCH, an indicator associated with a hybrid automatic repeat request (HARQ), or an indicator indicating that a discontinuous reception (DRX) inactivity timer is not activated while the preconfigured PDSCH is received.

According to embodiments of the present disclosure, the at least one processor is further configured to receive the preconfigured PDSCH based on at least one of a specific cycle, a specific resource block (RB) where the PDSCH for a data reception is not allocated, or a preconfigured reference value, the preconfigured PDSCH comprises the third information, the decoding is performed on the preconfigured PDSCH, he second information is used for a communication system using an artificial intelligence (AI) model or a link adaptation, and the link adaptation determines a modulation coding scheme (MCS) based on the second information.

According to embodiments of the present disclosure, a base station in a wireless communication system is provided, the base station comprising: a transceiver; and at least one processor coupled with the transceiver and configured to: transmit, to a terminal, a first message comprising first information for transmitting a preconfigured physical downlink shared channel (PDSCH), transmit, to the terminal, the preconfigured PDSCH, and receive, from the terminal, second information based on a result of decoding on the preconfigured PDSCH, wherein the preconfigured PDSCH is used to collect third information for improving a quality of data transmission or reception, and wherein the at least one processor is further configured to transmit the preconfigured PDSCH based on a time when a PDSCH for data transmission is not transmitted.

According to embodiments of the present disclosure, a method performed by a terminal in a wireless communication system is provided, the method comprising: receiving, from a base station, a first message comprising first information for receiving a preconfigured physical downlink shared channel (PDSCH); based on the first information, receiving, from the base station, the preconfigured PDSCH; decoding on the received preconfigured PDSCH; and transmitting, to the base station, second information on a result of the decoding, wherein the preconfigured PDSCH is used to collect third information for improving a quality of data transmission or reception, and wherein the preconfigured PDSCH is received based on a time when a PDSCH for data reception is not received.

According to embodiments of the present disclosure, a method performed by a base station in a wireless communication system is provided, the method comprising: transmitting, to a terminal, a first message comprising first information for transmitting a preconfigured physical downlink shared channel (PDSCH); transmitting, to the terminal, the preconfigured PDSCH; and receiving, from the terminal, second information based on a result of decoding on the preconfigured PDSCH, wherein the preconfigured PDSCH is used to collect third information for improving a quality of data transmission or reception, and wherein the preconfigured PDSCH is transmitted based on a time when a PDSCH for data transmission is not transmitted.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a basic structure of a time-frequency domain in a wireless communication system according to an embodiment of the disclosure;

FIG. 2 illustrates structures of a frame, a subframe, and a slot in a wireless communication system according to an embodiment of the disclosure;

FIG. 3 illustrates an example of a configuration of a bandwidth part (BWP) in a wireless communication system according to an embodiment of the disclosure;

FIG. 4 illustrates an example of a configuration of a control resource set of a downlink control channel in a wireless communication system according to an embodiment of the disclosure;

FIG. 5 illustrates a structure of a downlink control channel in a wireless communication system according to an embodiment of the disclosure;

FIG. 6 illustrates a method in which a base station and a UE perform data transmission/reception by considering a downlink data channel and a rate matching resource according to an embodiment of the disclosure;

FIG. 7 illustrates an example of frequency-domain resource allocation of a PDSCH in a wireless communication system according to an embodiment of the disclosure;

FIG. 8 illustrates an example of time-domain resource allocation of a PDSCH in a wireless communication system according to an embodiment of the disclosure;

FIG. 9 illustrates an example of time-domain resource allocation based on subcarrier spacings of a data channel and a control channel in a wireless communication system according to an embodiment of the disclosure;

FIG. 10 illustrates radio protocol structures of a base station and a UE in single cell, carrier aggregation, and dual connectivity situations in a wireless communication system according to an embodiment of the disclosure;

FIG. 11 illustrates an example of a LA structure using AI according to an embodiment of the disclosure;

FIG. 12 illustrates an example of a process for transmitting a preconfigured PDSCH by utilizing spare resources according to an embodiment of the disclosure;

FIG. 13 illustrates an example of use in CDRX when a preconfigured PDSCH is transmitted using a periodic transmission method according to an embodiment of the disclosure;

FIG. 14 illustrates an example of checking results for multiple AI candidate models (bandits) according to an embodiment of the disclosure;

FIG. 15 illustrates an example of checking results for multiple tuning values according to an embodiment of the disclosure;

FIG. 16 illustrates an example of performing link adaptation using a preconfigured PDSCH according to an embodiment of the disclosure;

FIG. 17 illustrates a process in which a UE requests and receives a preconfigured PDSCH to support an AI model from a base station in an environment when a model related to AI communication exists in the UE according to an embodiment of the disclosure;

FIG. 18 illustrates a process in which a UE requests and receives a preconfigured PDSCH to support an AI model from a base station in an environment when a model related to AI communication exists in the UE according to an embodiment of the disclosure;

FIG. 19 illustrates a process in which a base station transmits a preconfigured PDSCH to a UE in an environment or link application when a model related to AI communication exists in the base station according to an embodiment of the disclosure;

FIG. 20 illustrates a process in which a base station transmits a preconfigured PDSCH to a UE in an environment or link application when a model related to AI communication exists in the base station according to an embodiment of the disclosure;

FIG. 21 illustrates an example of a structure of a UE according to an embodiment of the disclosure; and

FIG. 22 illustrates an example of a structure of a base station according to an embodiment of the disclosure.

### DETAILED DESCRIPTION

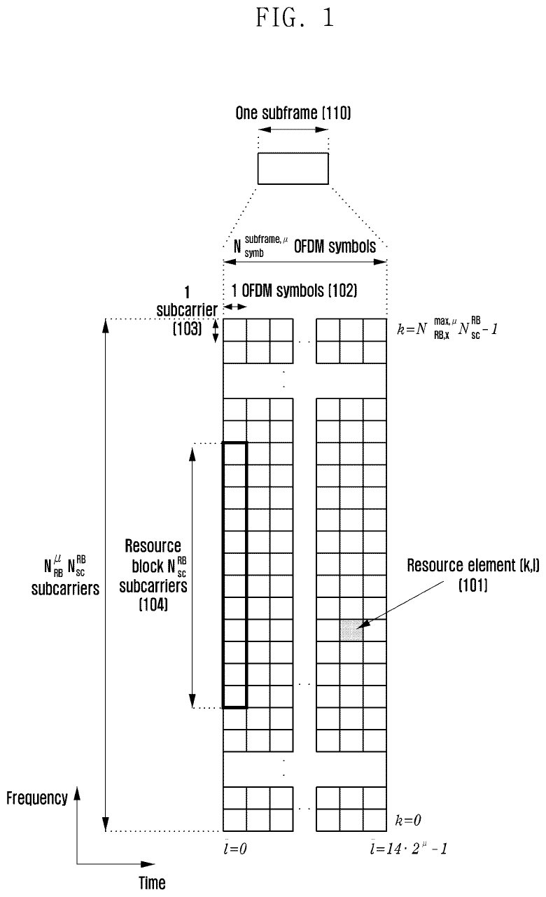

FIGS. 1 through 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing embodiments, descriptions of technical contents well-known in the art and not directly related to the disclosure will be omitted.

This is to more clearly convey the subject matter of the disclosure without obscuring it by omitting unnecessary description.

For the same reason, some elements are exaggerated, omitted, or schematically illustrated in the accompanying drawings. In addition, the depicted size of each element does not completely reflect the actual size. In the drawings, the same or corresponding elements are assigned the same reference numerals.

The advantages and features of the disclosure and ways to achieve them will be apparent by making reference to embodiments as described below in detail in conjunction with the accompanying drawings.

However, the disclosure is not limited to the embodiments set forth below, but may be implemented in various different forms. The following embodiments are provided to inform those skilled in the art of the scope of the disclosure, and the disclosure is defined only by the scope of the appended claims. Throughout the description herein, the same or like reference numerals designate the same or like elements.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. A “unit” may be constructed either to be stored in an addressable storage medium or to execute one or more processors. Therefore, a “unit” includes, for example, software elements, object-oriented software elements, class elements or task elements, processes, functions, properties, procedures, subroutines, segments of a program code, drivers, firmware, micro-codes, circuits, data, database, data structures, tables, arrays, and variables. The functions provided by elements and units may be combined into those of a smaller number of elements and units or separated into those of a larger number of elements and units. In addition, the elements and units may be implemented to operate one or more central processing units (CPUs) within a device or a secure multimedia card.

For the convenience of description, some of the terms and names defined in the 3rd generation partnership project (3GPP) standards (e.g., standards for 5G, NR, LTE or similar systems) may be used. In addition, terms and names newly defined in the next-generation communication system (e.g., 6G, Beyond 5G system) to which the disclosure can be applied, or terms and names used in the existing communication systems may be used. The use of such terms is not limited by the terms and names of the disclosure, may be equally applied to systems conforming to other standards, and may be changed into other forms without departing from the subject matter of the disclosure. Embodiments of the disclosure may be easily modified and applied to other communication systems.

In the disclosure, singular expressions such as “a/an” and “the” may include plural expressions unless the context clearly dictates otherwise.

In the disclosure, expressions including ordinal numbers such as “first” and “second” may indicate various elements. The above expressions do not limit the sequence or importance of the elements, and are used merely for the purpose to distinguish one element from the others. For example, without departing from the scope of the disclosure, a first element may be referred to as a second element, and similarly a second element may be also referred to as a first element.

In the disclosure, the term “and/or” includes a combination of a plurality of specified items or any of a plurality of specified items.

In the disclosure, terms used herein may be merely to describe a certain embodiment, and may not be intended to limit the disclosure. The singular expressions may include plural expressions unless the context clearly dictates otherwise. In the disclosure, the terms such as “comprise,” “include,” and “have” denote the presence of stated elements, components, operations, functions, features, and the like, but do not exclude the presence of or a possibility of addition of one or more other elements, components, operations, functions, features, and the like.

In the disclosure, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

In the disclosure, an expression of more than or less than is used to determine whether or not a specific condition is satisfied or fulfilled, but this is only a description for expressing an example and does not exclude a description of a specific number or more or a specific number or lower. A condition described as a “specific number or more” may be replaced with “more than a specific number,” a condition described as a “specific number or lower” may be replaced with “less than a specific number,” and a condition described as a “specific number or more and less than a specific number” may be replaced with “more than a specific number and a specific number or lower.”

In addition, although the disclosure describes various embodiments using terms used in some communication standards (e.g., 3rd generation partnership project (3GPP)), this is only an example for description. Various embodiments of the disclosure may be easily modified and applied in other communication systems.

Before going into a detailed description of the disclosure, examples of possible interpretations of some terms used herein are provided. However, it should be noted that the interpretations provided below are not limited to the examples.

In the disclosure, a terminal (or a communication terminal) is an entity that communicates with a base station or another terminal, and may also be referred to as a node, a user equipment (UE), a next-generation (NG) UE, a mobile station (MS), a device, or the like. In addition, the terminal may include at least one of a smartphone, a tablet PC, a mobile phone, a video phone, an e-book reader, a desktop PC, a laptop PC, a netbook computer, a personal digital assistant (PDA), a portable multimedia player (PMP), an MP3 player, a medical device, a camera, or a wearable device. In addition, the terminal may include at least one of a television, a digital video disk (DVD) player, an audio player, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, or an electronic picture frame. In addition, the terminal may include at least one of a medical device (such as portable medical measuring devices (including a glucometer, a heart rate monitor, a blood pressure monitor, or a body temperature thermometer), a magnetic resonance angiography (MRA) device, a magnetic resonance imaging (MRI) device, a computed tomography (CT) device, a camcorder, or a microwave scanner), a navigation device, a global navigation satellite system (GNSS), an event data recorder (EDR), a flight data recorder (FDR), an automotive infotainment device, marine electronic equipment (such as marine navigation system or gyro compass), aviation electronics (avionics), security equipment, an automotive head unit, an industrial or household robot, a drone, an automatic teller machine (ATM), a point of sales (POS) terminal, or an Internet-of-things (IoT) device (such as electric bulb, sensor, sprinkler system, fire alarm system, temperature controller, street lamp, toaster, fitness equipment, hot water tank, heater, or boiler). In addition, the terminal may include various types of multimedia systems capable of performing communication functions. Meanwhile, the disclosure is not limited to the above terms, and the terminal may also be referred to as any other term having the same or similar meaning.

In the disclosure, a base station is an entity that communicates with a terminal and performs resource allocation of the terminal, and may have various forms. The base station may also be referred to as a base station (BS), a NodeB (NB), a next-generation radio access network (NG RAN), an access point (AP), a transmission reception point (TRP), a wireless access unit, a base station controller, or a node on a network. Or, depending on the separation of functions, the base station may be referred to as a central unit (CU) or a distributed unit (DU). Meanwhile, the disclosure is not limited to the above terms, and the base station may also be referred to as any other term having the same or similar meaning.

In the disclosure, a radio resource control (RRC) message may be referred to as high-level information, a high-level message, a high-level signal, a high-level signaling, a high layer signaling, or a higher layer signaling. The disclosure is not limited thereto, and may use any other term having the same or similar meaning.

In the disclosure, data may be referred to as user data, user plane (UP) data, or application data, or may be referred to as any other term having the same or similar meaning as signals transmitted and received via a data radio bearer (DRB).

In the disclosure, the direction of data transmitted from a terminal may be referred to as uplink (UL), and the direction of data transmitted to a terminal may be referred to as downlink (DL). Therefore, in the case of uplink transmission, a transmitter may refer to a terminal, and a receiver may refer to a base station or a certain network entity of a communication system. Also, in the case of downlink transmission, a transmitter may refer to a base station or a certain network entity of a communication system, and a receiver may refer to a terminal.

Hereinafter, the frame structure of a 5G system will be described in detail with reference to the drawings.

FIG. 1 illustrates a basic structure of a time-frequency domain, which is a radio resource domain in which a data or control channel is transmitted in the 5G system.

In FIG. 1, the horizontal axis represents a time domain, and the vertical axis represents a frequency domain. A basic unit of resources in the time-frequency domain is a resource element (RE) 101. The resource element 101 may be defined as one orthogonal frequency division multiplexing (OFDM) symbol 102 in the time domain and one subcarrier 103 in the frequency domain. In the frequency domain, N_{SC}^{RB}(for example, 12) consecutive REs may constitute one resource block (RB) 104.

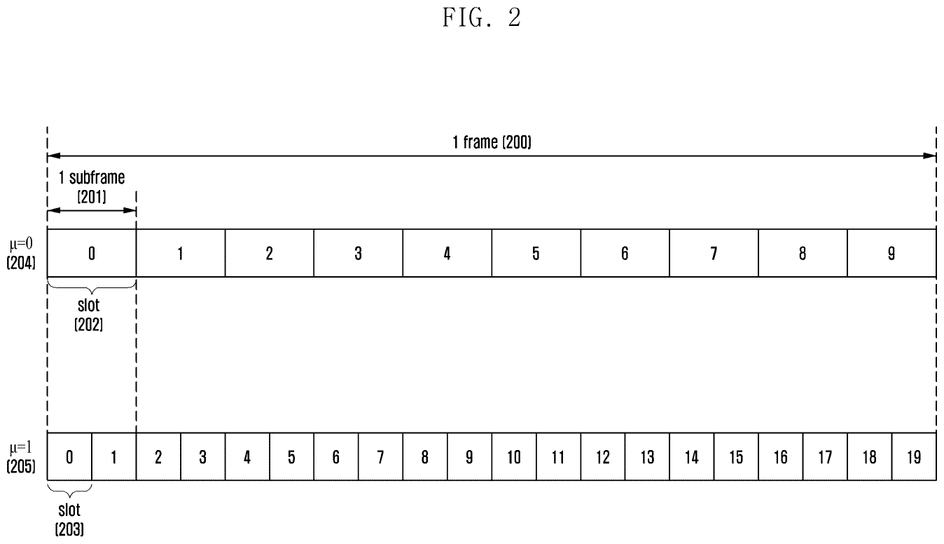

FIG. 2 illustrates structures of a frame, a subframe, and a slot in a wireless communication system according to an embodiment of the disclosure.

In FIG. 2, an example of structures of a frame 200, a subframe 201, and a slot 202 is shown. One frame 200 may be defined as 10 ms. One subframe 201 may be defined as 1 ms, and thus the one frame 200 may be composed of ten subframes 201 in total. One slot 202 or 203 may be defined as fourteen OFDM symbols (i.e., the number of symbols for one slot (N_{symb}^{slot})=14). One subframe 201 may include one or multiple slots 202 and 203, and the number of slots 202 and 203 per one subframe 201 may differ according to a configuration value (μ) 204 or 205 for a subcarrier spacing. In the example of FIG. 2, cases in which the subcarrier spacing configuration value is μ=0 (204) and μ=1 (205) are illustrated. If μ=0 (204), one subframe 201 may be composed of one slot 202, and if μ=1 (205), one subframe 201 may be composed of two slots 203. That is, the number of slots per one subframe (Nₛₗₒₜ^{subframe,μ}) may differ according to a subcarrier spacing configuration value μ, and accordingly, the number of slots per one frame (Nₛₗₒₜ^{frame,μ}) may differ. According to each subcarrier spacing configuration μ, Nₛₗₒₜ^{subframe,μ} and Nₛₗₒₜ^{frame,μ} may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, the bandwidth part (BWP) configuration in a 5G communication system will be described in detail with reference to the drawings.

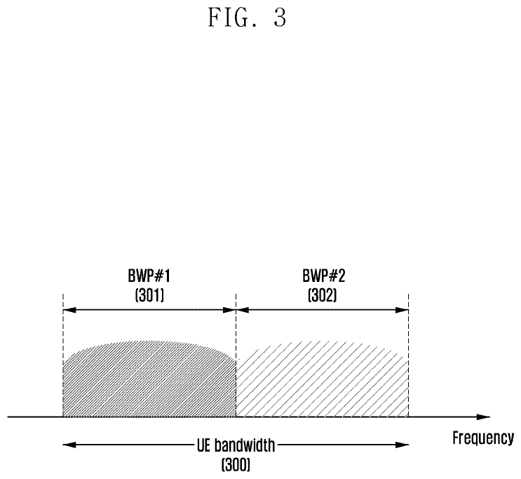

FIG. 3 illustrates an example of the configuration of BWP in a wireless communication system according to an embodiment of the disclosure.

In FIG. 3, an example is provided in which a UE bandwidth 300 is configured with two BWPs, that is, BWP #1 301 and BWP #2 302. The base station may configure one or multiple BWPs for the UE, and may configure information as shown in Table 2 below for each BWP.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

The above example is not a limitation, and various parameters related to a BWP may be configured in the UE in addition to the above configuration information. The above information may be transmitted by the base station to the UE via higher layer signaling, for example, radio resource control (RRC) signaling. At least one BWP among the configured one or multiple BWPs may be activated. Whether to activate the configured BWP may be semi-statically transmitted from the base station to the UE via RRC signaling or may be dynamically transmitted through downlink control information (DCI).

According some embodiments, the UE before RRC connection may be configured with an initial BWP for initial access from the base station through a master information block (MIB). Specifically, through the MIB in an initial access step, the UE may receive configuration information about a search apace and a control resource set (CORESET) through which the PDCCH for reception of system information required for initial access (which may correspond to remaining system information (RMSI) or system information block 1 (SIB 1)) can be transmitted. The CORESET and search space, which are configured through the MIB, may be regarded as identifier (ID) 0, respectively. The base station may notify the UE of configuration information such as frequency allocation information, time allocation information, and numerology for the control resource set #0 through the MIB. In addition, the base station may notify the UE of configuration information regarding the monitoring periodicity and occasion for the control resource set #0, that is, configuration information regarding the search space #0, through the MIB. The UE may regard the frequency domain configured as the control resource set #0, obtained from the MIB, as an initial BWP for initial access. Here, the ID of the initial BWP may be regarded as zero.

The configuration of the BWP supported by 5G may be used for various purposes.

According to some embodiments, when a bandwidth supported by the UE is less than a system bandwidth, this may be supported through the BWP configuration. For example, the base station configures, in the UE, a frequency location (configuration information 2) of the BWP to enable the UE to transmit or receive data at a specific frequency location within the system bandwidth.

In addition, according to some embodiments, the base station may configure multiple BWPs in the UE for the purpose of supporting different numerologies. For example, in order to support both data transmission/reception using a subcarrier spacing of 15 kHz and a subcarrier spacing of 30 kHz in a certain UE, two BWPs may be configured with a subcarrier spacing of 15 kHz and a subcarrier spacing of 30 kHz, respectively. Different BWPs may be frequency division multiplexed, and when attempting to transmit or receive data at a specific subcarrier spacing, the BWP configured with that subcarrier spacing may be activated.

In addition, according to some embodiments, the base station may configure, for the UE, the BWPs having bandwidths of different sizes for the purpose of reducing power consumption of the UE. For example, when the UE supports a very large bandwidth, for example, a bandwidth of 100 MHz, and always transmits or receives data at that bandwidth, the transmission or reception may cause very high power consumption in the UE. In particular, when the UE performs monitoring on an unnecessary downlink control channels of a large bandwidth of 100 MHz even when there is no traffic, the monitoring may be very inefficient in terms of power consumption. Therefore, in order to reduce power consumption of the UE, the base station may configure, for the UE, a BWP of a relatively small bandwidth, for example, a BWP of 20 MHz. In a situation without traffic, the UE may perform a monitoring operation on a BWP of 20 MHz, and when data has occurred, the UE may transmit or receive data in a BWP of 100 MHz according to an indication of the base station.

In a method of configuring the BWP, the UEs before the RRC connection may receive configuration information about the initial BWP through a master information block (MIB) in the initial connection step. Specifically, from the MIB of a physical broadcast channel (PBCH), the UE may be configured with a control resource set (CORESET) for a downlink control channel through which downlink control information (DCI) for scheduling a system information block (SIB) may be transmitted. The bandwidth of the control resource set configured through the MIB may be regarded as the initial BWP, and the UE may receive, through the configured initial BWP, a physical downlink shared channel (PDSCH) through which the SIB is transmitted. The initial BWP may be used for other system information (OSI), paging, and random access as well as the reception of the SIB.

When one or more BWPs have been configured for the UE, the base station may indicate the UE to change (or switch, transition) the BWP by using a bandwidth part indicator field in DCI. As an example, in FIG. 3, when the currently activated BWP of the UE is BWP #1 301, the base station may indicate BWP #2 302 to the UE by using the BWP indicator in DCI, and the UE may perform a BWP switch to the BWP #2 302 indicated by the BWP indicator in the received DCI.

As described above, since the DCI-based BWP switch may be indicated by the DCI scheduling the PDSCH or PUSCH, when receiving a request to switch the BWP, the UE may be able to receive or transmit the PDSCH or PUSCH, which is scheduled by the DCI, without difficulty in the switched BWP. To this end, the standard stipulates requirements for a delay time (T_{BWP}) required when switching the BWP, and it may be defined as in Table 3 below.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the BWP switch delay time support type 1 or type 2 depending on UE capability. The UE may report a BWP delay time type that is supportable to the base station.

When the UE receives the DCI including the BWP switch indicator in slot n according to the requirements for the BWP switch delay time, the UE may complete a switch to a new BWP indicated by the BWP switch indicator at a time not later than slot n+T_{BWP}, and may perform transmission and reception for a data channel scheduled by the corresponding DCI in the switched new BWP. When the base station intends to schedule the data channel to the new BWP, the base station may determine a time domain resource assignment for the data channel by considering the BWP switch delay time (T_{BWP}) of the UE. That is, when scheduling the data channel to the new BWP, the base station may schedule the data channel after the BWP switch delay time in a method for determining time domain resource assignment for the data channel. Therefore, the UE may not expect the DCI indicating the BWP switch to indicate a slot offset (K0 or K2) value less than the T_{BWP}.

If the UE receives the DCI (e.g., DCI format 1_1 or 0_1) indicating the BWP switch, the UE may not perform transmission or reception during a time interval from a third symbol of the slot in which the PDCCH including the DCI is received, to a start time of the slot indicated by the slot offset (KG or K2) value indicated by the time domain resource allocation indicator field in the DCI. For example, if the UE has received the DCI indicating the BWP switch in slot n and the slot offset value indicated by the DCI is K, the UE may not perform transmission or reception from the third symbol of the slot n to the symbol prior to slot n+K (i.e., the last symbol of slot n+K−1).

Next, a synchronization signal (SS)/PBCH block in 5G will be described.

The SS/PBCH block may refer to a physical layer channel block composed of a primary SS (PSS), a secondary SS (SSS), and a PBCH. Specifically, they are as follows:
PSS: this is a signal serving as a reference for downlink time/frequency synchronization and provides some information of a cell ID;
SSS: this is a signal serving as a reference for downlink time/frequency synchronization, and provides the remaining cell ID information that is not provided by the PSS. In addition, SSS may serve as a reference signal for demodulation of the PBCH;
PBCH: this provides essential system information required for transmission or reception of a data channel and a control channel of a UE. The essential system information may include search space related control information indicating radio resource mapping information of a control channel, scheduling control information for a separate data channel for transmission of system information, and the like; and/or
SS/PBCH block: this is composed of a combination of the PSS, the SSS, and the PBCH. One or multiple SS/PBCH blocks may be transmitted within 5 ms, and the respective SS/PBCH blocks transmitted may be distinguished by indexes.

The UE may detect the PSS and the SSS in the initial access step and may decode the PBCH. The UE may obtain the MIB from the PBCH and may be configured with CORESET #0 (which may correspond to the control resource set having CORESET index of 0) therefrom. The UE may monitor the control resource set #0 under the assumption that a demodulation reference signal (DMRS) transmitted in the selected SS/PBCH block and the control resource set #0 is quasi-co-located (QCLed). The UE may receive system information with downlink control information transmitted from the control resource set #0. The UE may obtain, from the received system information, configuration information related to a random access channel (RACH) required for initial access. The UE may transmit a physical RACH (PRACH) to the base station by considering the selected SS/PBCH index, and the base station having received the PRACH may obtain information about an SS/PBCH block index selected by the UE. The base station may know which block is selected among the SS/PBCH blocks by the UE, and may know that the control resource set #0 associated therewith is monitored.

Next, downlink control information (DCI) in a 5G system will be described in detail.

In the 5G system, scheduling information about uplink data (or physical uplink shared channel (PUSCH)) or downlink data (or physical downlink shared channel (PDSCH)) is transmitted from the base station to the UE through the DCI. For the PUSCH or the PDSCH, the UE may monitor a fallback DCI format and a non-fallback DCI format. The fallback DCI format may include a fixed field predefined between the base station and the UE, and the non-fallback DCI format may include a configurable field.

The DCI may be transmitted through a physical downlink control channel (PDCCH) after channel coding and modulation is performed thereon. A cyclic redundancy check (CRC) may be attached to a DCI message payload, and the CRC may be scrambled by a radio network temporary identifier (RNTI) corresponding to the identifier of the UE. Different RNTIs may be used according to the purpose of the DCI message, for example, a UE-specific data transmission, a power adjustment command, or a random access response. That is, the RNTI is not explicitly transmitted, but is included in a CRC calculation process and then transmitted. Upon receiving the DCI message transmitted through the PDCCH, the UE may check a CRC by using an assigned RNTI. When a CRC check result is correct, the UE may know that the corresponding message has been transmitted to the UE.

For example, the DCI for scheduling a PDSCH for system information (SI) may be scrambled by an SI-RNTI. The DCI for scheduling a PDSCH for a random access response (RAR) message may be scrambled by an RA-RNTI. The DCI for scheduling a PDSCH for a paging message may be scrambled by a P-RNTI. The DCI for notifying of a slot format indicator (SFI) may be scrambled by an SFI-RNTI. The DCI for notifying of transmit power control (TPC) may be scrambled by a TPC-RNTI. The DCI for scheduling UE-specific PDSCH or PUSCH may be scrambled by a cell RNTI (C-RNTI).

DCI format 0_0 may be used as a fallback DCI for scheduling a PUSCH. Here, a CRC may be scrambled by a C-RNTI. The DCI format 0_0 in which the CRC is scrambled by the C-RNTI may include, for example, the following information in Table 4.

TABLE 4
- Identifier for DCI formats - [1] bit
- Frequency domain resource assignment -[┌log₂( N_{RB}^{UL,BWP}(N_{RB}^{UL,BWP} +
1)/2)┐ ] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- TPC (transmit power control) command for scheduled PUSCH - [2] bits
- UL/SUL (supplementary US) indicator - 0 or 1 bit

DCI format 0_1 may be used as a non-fallback DCI for scheduling a PUSCH. Here, a CRC may be scrambled by a C-RNTI. The DCI format 0_1 in which the CRC is scrambled by the C-RNTI may include, for example, the following information in Table 5.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
        • For resource allocation type 0, ┌N_{RB}^{UL,BWP}/P┐ bits
        • For resource allocation type 1, ┌log₂(N_{RB}^{UL,BWP}(N_{RB}^{UL,BWP} + 1)/2)┐ bits
  - Time domain resource assignment - 1, 2, 3, or 4 bits
  - VRB (virtual resource block)-to-PRB (physical resource block) mapping - 0 or 1
bit, only for resource allocation type 1.
        • 0 bit if only resource allocation type 0 is configured;
        • 1 bit otherwise.
  - Frequency hopping flag - 0 or 1 bit, only for resource allocation type 1.
        • 0 bit if only resource allocation type 0 is configured;
        • 1 bit otherwise.
  - Modulation and coding scheme - 5 bits
  - New data indicator - 1 bit
  - Redundancy version - 2 bits
  - HARQ process number - 4 bits
  - 1st downlink assignment index - 1 or 2 bits
        • 1 bit for semi-static HARQ-ACK codebook;
        • 2 bits for dynamic HARQ-ACK codebook with single HARQ-ACK
          codebook.
  - 2nd downlink assignment index - 0 or 2 bits
        • 2 bits for dynamic HARQ-ACK codebook with two HARQ-ACK sub-
          codebooks;
        • 0 bit otherwise.
  - TPC command for scheduled PUSCH - 2 bits
  $‐ SRS resource indicator - ⌈ {log}_{2} ( {\sum }_{k = 1}^{{L}_{max} \sum } ( \begin{matrix}{N}_{SRS} \\ k\end{matrix} ) ( ) ) □□ ⌉ or ⌈ {log}_{2} ( {N}_{SRS} ) ⌉ bits$
        $⌈ {log}_{2} ( {\sum }_{k = 1}^{{L}_{max} \sum } ( \begin{matrix}{N}_{SRS} \\ k\end{matrix} ) ( ) ) □□ ⌉ bits for non - codebook based PUSCH$
            transmission;
        • ┌log₂(N_{SRS})┐ bits for codebook based PUSCH transmission.
  - Precoding information and number of layers -up to 6 bits
  - Antenna ports - up to 5 bits
  - SRS request - 2 bits
  - CSI request - 0, 1, 2, 3, 4, 5, or 6 bits
  - CBG (code block group) transmission information - 0, 2, 4, 6, or 8 bits
  - PTRS (phase tracking reference signal)-DMRS (demodulation reference signal)
association - 0 or 2 bits.
  - beta_offset indicator - 0 or 2 bits
  - DMRS sequence initialization - 0 or 1 bit
```

DCI format 1_0 may be used as a fallback DCI for scheduling a PDSCH. Here, a CRC may be scrambled by a C-RNTI. The DCI format 1_0 in which the CRC is scrambled by the C-RNTI may include, for example, the following information in Table 6.

TABLE 6
- Identifier for DCI formats - [1] bit
- Frequency domain resource assignment -[┌log₂( N_{RB}^{DL,BWP}(N_{RB}^{DL,BWP} +
1)/2)┐ ] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- PUCCH (physical uplink control channel) resource indicator - 3 bits
- PDSCH-to-HARQ feedback timing indicator - [3] bits

DCI format 1_1 may be used as a non-fallback DC for scheduling a PDSCH. Here, a CRC may be scrambled by a C-RNTI. The DCI format 1_1 in which the CRC is scrambled by the C-RNTI may include, for example, the following information.

```
TABLE 7
  - Carrier indicator - 0 or 3 bits
  - Identifier for DCI formats - [1] bits
  - Bandwidth part indicator - 0, 1 or 2 bits
  - Frequency domain resource assignment
      • For resource allocation type 0, ┌N_{RB}^{DL, BWP}/P┐ bits
      • For resource allocation type 1, ┌log₂( N_{RB}^{DL, BWP}(N_{RB}^{DL, BWP} +
        1)/2)┐ bits
  - Time domain resource assignment -1, 2, 3, or 4 bits
  - VRB-to-PRB mapping - 0 or 1 bit, only for resource allocation type 1.
      • 0 bit if only resource allocation type 0 is configured;
      • 1 bit otherwise.
  - PRB (physical resource block) bundling size indicator - 0 or 1 bit
  - Rate matching indicator - 0, 1, or 2 bits
  - ZP (zero power) CSI-RS (channel state information reference signal)
trigger - 0, 1, or 2 bits
  For transport block 1:
    - Modulation and coding scheme - 5 bits
    - New data indicator - 1 bit
    - Redundancy version - 2 bits
  For transport block 2:
    - Modulation and coding scheme - 5 bits
    - New data indicator - 1 bit
    - Redundancy version - 2 bits
  - HARQ process number - 4 bits
  - Downlink assignment index - 0 or 2 or 4 bits
  - TPC command for scheduled PUCCH - 2 bits
  - PUCCH resource indicator - 3 bits
  - PDSCH-to-HARQ_feedback timing indicator - 3 bits
  - Antenna ports - 4, 5 or 6 bits
  - Transmission configuration indication - 0 or 3 bits
  - SRS request - 2 bits
  - CBG (code block group) transmission information - 0, 2, 4, 6, or 8 bits
  - CBG flushing out information - 0 or 1 bit
  - DMRS sequence initialization - 1 bit
```

A downlink control channel in a 5G communication system will be described below in detail with reference to the drawings.

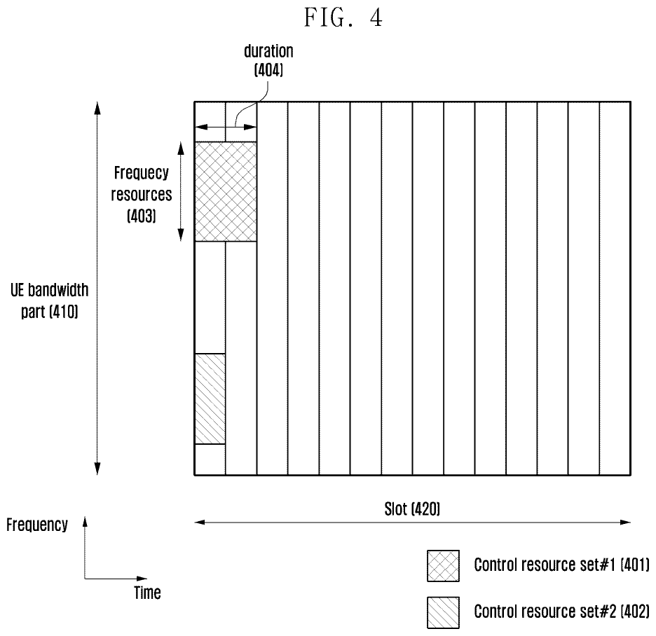

FIG. 4 illustrates an example of a control resource set (CORESET) where a downlink control channel is transmitted in a 5G wireless communication system. FIG. 4 shows an example in which a UE BWP 410 is configured in a frequency domain and two CORESETs (CORESET #1 401 and CORESET #2 402) are configured within one slot 420 in a time domain. The CORESETs 401 and 402 may be configured in specific frequency resources 403 within the entire UE BWP 410 in the frequency domain. One or multiple OFDM symbols may be configured in the time domain and defined as a control resource set duration 404. In an example shown in FIG. 4, the CORESET #1 401 is configured with the control resource set duration of two symbols, and the CORESET #2 402 is configured with the control resource set duration of one symbol.

The above-described CORESET in 5G may be configured for the UE by the base station via higher layer signaling (e.g., system information (SI), master information block (MIB), radio resource control (RRC) signaling). Configuring the CORESET for the UE refers to providing information such as a CORESET identity, a frequency location of the CORESET, a symbol length of the CORESET, and the like. For example, the CORESET may include the following information in Table 8.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(CORESSET identity)

| | |
|---|---|
| frequencyDomainResources | BIT STRING (SIZE (45)), |

(Frequency domain resource allocation information)

| | |
|---|---|
| duration | INTEGER (1..maxCoReSetDuration), |

(Time domain resource allocation information

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG-bundle, allContiguousRBs}, |
| interleaverSize | ENUMERATED {n2, n3, n6} |

(Interleaver size)

| | |
|---|---|
| shiftIndex | INTEGER(0..maxNrofPhysicalResourceBlocks-1) |

OPTIONAL
(Interleaver shift)
},

| | |
|---|---|
| nonInterleaved | NULL |

},

| | |
|---|---|
| tci-StatesPDCCH | SEQUENCE(SIZE (1..maxNrofTCI-StatesPDCCH)) OF TCI-StateId |

OPTIONAL,
(QCL configuration information)

| | |
|---|---|
| tci-PresentInDCI | ENUMERATED {enabled} OPTIONAL, -- Need S |

}

In Table 8, tci-StatesPDCCH (simply referred to as transmission configuration indication (TCI) state) configuration information may include information about one or multiple synchronization signal/physical broadcast channel (SS/PBCH) block indexes or channel state information reference signal (CSI-RS) indexes having a QCL relationship with a DMRS transmitted in the corresponding CORESET.

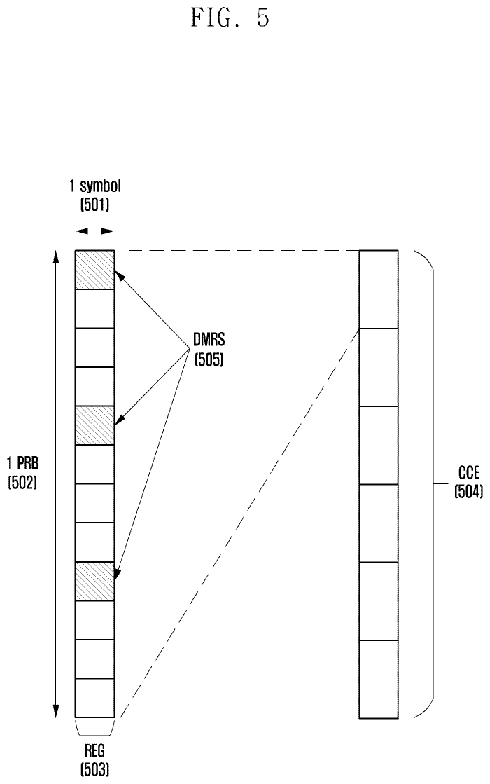

FIG. 5 illustrates an example of the basic unit of time and frequency resources configuring a downlink control channel that can be used in 5G. According to FIG. 5, the basic unit of time and frequency resources configuring a control channel may be referred to as a resource element group (REG) 503, which may be defined as one OFDM symbol 501 in a time domain and one physical resource block (PRB) 502, i.e., 12 subcarriers, in a frequency domain. The base station may concatenate the REGs 503 to configure a downlink control channel allocation unit.

As shown in FIG. 5, when a basic unit to which a downlink control channel is allocated in 5G is referred to as a control channel element (CCE) 504, one CCE 504 may consist of multiple REGs 503. In the example shown in FIG. 5, the REG 503 may include 12 REs, and when one CCE 504 consist of six REGs 503, one CCE 504 may include 72 REs. When the downlink CORESET is configured, the CORESET may include multiple CCEs 504. A specific downlink control channel may be transmitted after being mapped to one or more CCEs 504 according to an aggregation level (AL) in the CORESET. The CCEs 504 in the CORESET are distinguished by numbers. Here, the numbers of the CCEs 504 may be assigned according to a logical mapping scheme.

The basic unit of the downlink control channel shown in FIG. 5, that is, the REG 503 may include both REs to which DCI is mapped and a region to which a DMRS 505 which is a reference signal for decoding the DCI is mapped. As shown in FIG. 5, three DMRSs 505 may be transmitted in one REG 503. The number of CCEs required for transmission of the PDCCH may be 1, 2, 4, 8, or 16 according to the AL. A different number of CCEs may be used to implement link adaptation of the downlink control channel. For example, if AL=L, one downlink control channel may be transmitted through L CCEs. The UE needs to detect a signal in a state in which the UE does not know information about the downlink control channel, and a search space representing a set of CCEs has been provided for blind decoding. The search space is a set of downlink control channel candidates including CCEs that the UE has to attempt to decode at a given AL. Since there are various ALs that make one bundle of 1, 2, 4, 8, or 16 CCEs, the UE may have multiple search spaces. A search space set may be defined as a set of search spaces at all configured ALs.

The search space may be classified into a common search space and a UE-specific search space. A predetermined group of UEs or all the UEs may examine the common search space of the PDCCH so as to receive cell common control information such as dynamic scheduling of system information or a paging message. For example, PDSCH scheduling allocation information for transmission of the SIB including cell operator information and the like may be received by examining the common search space of the PDCCH. In a case of the common search space, since a predetermined group of UEs or all the UEs need to receive the PDCCH, the common search space may be provided as a set of previously appointed CCEs. Scheduling allocation information about the UE-specific PDSCH or PUSCH may be received by examining the UE-specific search space of the PDCCH. The UE-specific search space may be UE-specifically provided as a function of the UE identifier and various system parameters.

In 5G, the parameter for the search space of the PDCCH may be configured for the UE by the base station via higher layer signaling (e.g., SIB, MIB, RRC signaling, etc.). For example, the base station may configure, for the UE, the number of PDCCH candidates at each aggregation level L, the monitoring periodicity for the search space, the monitoring occasion of symbol units in the slots for the search space, the search space type (common search space or U-specific search space), the combination of RNTI and DCI format to be monitored in the search space, the control resource set index to monitor the search space, and the like. For example, the search space may include the following information in Table 9.

TABLE 9

| | |
|---|---|
| SearchSpace ::= | SEQUENCE { |

-- Identity of the search space. SearchSpaceId = 0 identifies the SearchSpace configured via
PBCH (MIB) or ServingCellConfigCommon.

| | |
|---|---|
| searchSpaceId | SearchSpaceId, |

(Search space identifier)

| | |
|---|---|
| controlResourceSetId | ControlResourceSetId, |

(CORESET identifier)

| | |
|---|---|
| monitoringSlotPeriodicityAndOffset | CHOICE { |

(Monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | OPTIONAL, |
| Duration (Monitoring length) | INTEGER (2..2559) |
| monitoringSymbolsWithinSlot | BIT STRING (SIZE (14)) OPTIONAL, |

(Monitoring symbol within slot)

| | |
|---|---|
| nrofCandidates | SEQUENCE { |

(Number of PDCCH candidates per aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

},

| | |
|---|---|
| searchSpaceType | CHOICE { |

(Search space type)
-- Configures this search space as common search space (CSS) and DCI formats to monitor.

| | |
|---|---|
| common | SEQUENCE { |

(Common search space)
}

| | |
|---|---|
| ue-Specific | SEQUENCE { |

-- Indicates whether the UE monitors in this USS for DCI formats 0-0 and 1-0 or for formats 0-
1 and 1-1.

| | |
|---|---|
| formats | ENUMERATED {formats0-0-And-1-0, formats0-1-And-1-1}, |

...
}

Based on configuration information, the base station may configure one or more search space sets for the UE. According to some embodiments, the base station may configure search space set 1 and search space set 2 in the UE. The base station may configure the search space set 1 in the UE so that DCI format A scrambled by an X-RNTI is monitored in the common search space. The base station may configure the search space set 2 in the UE so that DCI format B scrambled by a Y-RNTI is monitored in the UE-specific search space.

According to the configuration information, one or multiple search space sets may exist in the common search space or the UE-specific search space. For example, search space set #1 and search space set #2 may be configured as the common search space, and search space set #3 and search space set #4 may be configured as the UE-specific search space.

In the common search space, the following combinations of the DCI format and the RNTI may be monitored. However, the disclosure is not limited to below.
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

In the UE-specific search space, the following combinations of the DCI format and the RNTI may be monitored. However, the disclosure is not limited to below:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

The specified RNTIs may follow the definitions and usages described below:
Cell RNTI (C-RNTI): For UE-specific PDSCH scheduling;
Temporary cell RNTI (TC-RNTI): For UE-specific PDSCH scheduling;
Configured scheduling RNTI (CS-RNTI): For semi-statically configured UE-specific PDSCH scheduling;
Random access RNTI (RA-RNTI): For PDSCH scheduling in random access operation;
Paging RNTI (P-RNTI): For scheduling of PDSCH through which paging is transmitted;
System Information RNTI (SI-RNTI): For PDSCH scheduling in which system information is transmitted;
Interruption RNTI (INT-RNTI): For notifying of whether to puncture PDSCH;
Transmit Power Control for PUSCH RNTI (TPC-PUSCH-RNTI): For indication of power control command for PUSCH;
Transmit Power Control for PUCCH RNTI (TPC-PUCCH-RNTI): For indication of power control command for PUCCH; and/or
Transmit Power Control for SRS RNTI (TPC-SRS-RNTI): For indication of power control command for SRS.

The above-described specified DCI formats may follow the definition as in Table 10.

TABLE 10

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In 5G, the search space of the aggregation level L in the CORESET p and the search space set s may be expressed by Equation 1 below.

$$[ Equation 1 ]$$

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i$$

L: Aggregation level;
n_{CI}: Carrier index;
N_{CCE,p}: Total number of CCEs existing in the CORESET p;
n_{s,f}^{μ}: Slot index;
M_{s,max}^{(L)}: Number of PDCCH candidates of aggregation level L;
m_{s,n}_{_{CI}}=0, . . . , M_{s,max}^{(L)}−1: PDCCH candidate group index of aggregation level L;
i=0, . . . , L−1;
Y_{p,n}_{_{s,f}}_{^{μ}}=(Aₚ·Y_{p,n}_{_{s,f}}_{^{μ}}₋₁)mod D, Y_{p,-1}=n_{RNTI}≠0, Aₚ=39827 for pmod3=0, Aₚ=39829 for pmod3=1, Aₚ=39838 for pmod3=2, D=65537; and
n_{RNTI}: UE identifier.

In the case of the common search space, the Y_{p,n}_{_{s,f}}_{^{μ}} value may correspond to zero.

In the case of the UE-specific search space, the Y_{p,n}_{_{s,f}}_{^{μ}} value may correspond to a value that changes according to the UE identifier (C-RNTI or ID configured by the base station for the UE) and the time index.

In 5G, multiple search space sets may be configured with different parameters (e.g., parameters in Table 9), and thus the set of search space sets monitored by the UE may differ at each time point. For example, if search space set #1 is configured with the X-slot period, search space set #2 is configured with the Y-slot period, and X and Y are different, the UE may monitor both search space set #1 and space set #2 in a specific slot, and may monitor one of search space set #1 and search space set #2 in a specific slot.

Hereinafter, the rate matching operation and the puncturing operation are described in detail.

When time and frequency resources A where a symbol sequence A may be transmitted overlaps with certain time and frequency resources B, the rate matching or puncturing operation may be considered as a transmission and reception operation of channel A in view of a resource C where the resources A and B overlap. The specific operation may follow the contents below.

In the rate matching operation, the base station can map and transmit the channel A only for the remaining resource areas excluding the resource C corresponding to the overlapping area with the resources B in the entire resources A where the symbol sequence A may be transmitted to the UE. For example, if the symbol sequence A is composed of {symbol #1, symbol #2, symbol #3, symbol #4}, and if the resources A are {resource #1, resource #2, resource #3, resource #4} and the resources B are {resource #3, resource #5}, the base station can sequentially map the symbol sequence A to {resource #1, resource #2, resource #4}, which are the remaining resources in the resources A excluding {resource #3} corresponding to the resource C. As a result, the base station can transmit the symbol sequences {symbol #1, symbol #2, symbol #3} by mapping them to {resource #1, resource #2, resource #4}, respectively.

The UE can determine the resources A and the resources B from scheduling information for the symbol sequence A received from the base station, and can thereby determine the resource C, which is an overlapping area between the resources A and B. The UE can receive the symbol sequence A, assuming that the symbol sequence A is mapped to and transmitted in the remaining area of the entire resources A except for the resource C. For example, if the symbol sequence A is composed of {symbol #1, symbol #2, symbol #3, symbol #4}, and if the resources A are {resource #1, resource #2, resource #3, resource #4} and the resources B are {resource #3, resource #5}, the UE can assume that the symbol sequence A is sequentially mapped to {resource #1, resource #2, resource #4}, which are the remaining resources of the resources A except for {resource #3} corresponding to the resource C. As a result, the UE can perform a series of subsequent reception operations on the assumption that the symbol sequence of {symbol #1, symbol #2, symbol #3} is mapped to and transmitted in {resource #1, resource #2, resource #4}.

In the puncturing operation, if there is a resource C corresponding to an area overlapping with resources B in the entire resources A where a symbol sequence A may be transmitted to the UE, the base station maps the symbol sequence A to the entire resources A, but performs transmission only in the remaining resource area of the resources A excluding the resource C without performing transmission in the resource area corresponding to the resource C. For example, if the symbol sequence A is composed of {symbol #1, symbol #2, symbol #3, symbol #4}, and if the resources A are {resource #1, resource #2, resource #3, resource #4} and the resources B are {resource #3, resource #5}, the base station can map the symbol sequence A of {symbol #1, symbol #2, symbol #3, symbol #4} to the resources A {resource #1, resource #2, resource #3, resource #4}, and transmit only the symbol sequence of {symbol #1, symbol #2, symbol #4} corresponding to the remaining resources {resource #1, resource #2, resource #4} of the resources A excluding {resource #3} corresponding to the resource C without transmitting {symbol #3} mapped to {resource #3} corresponding to the resource C. As a result, the base station can transmit the symbol sequence of {symbol #1, symbol #2, symbol #4} by mapping them to {resource #1, resource #2, resource #4}.

The UE can determine the resources A and the resources B from scheduling information for the symbol sequence A received from the base station, and can thereby determine the resource C, which is an overlapping area between the resources A and B. The UE can receive the symbol sequence A, assuming that the symbol sequence A is mapped to the entire resources A but is transmitted only in the remaining area of the resources A except for the resource C. For example, if the symbol sequence A is composed of {symbol #1, symbol #2, symbol #3, symbol #4}, and if the resources A are {resource #1, resource #2, resource #3, resource #4} and the resources B are {resource #3, resource #5}, the UE can assume that the symbol sequence A of {symbol #1, symbol #2, symbol #3, symbol #4} is mapped to the resources A {resource #1, resource #2, resource #3, resource #4}, but {symbol #3} mapped to {resource #3} corresponding to the resource C is not transmitted, and the symbol sequence of {symbol #1, symbol #2, symbol #4} corresponding to {resource #1, resource #2, resource #4}, which are the remaining resources in the resources A except {resource #3} corresponding to the resource C, is transmitted. As a result, the UE can perform a series of subsequent reception operations on the assumption that the symbol sequence of {symbol #1, symbol #2, symbol #4} is mapped to and transmitted in {resource #1, resource #2, resource #4}.

Hereinafter, a method for configuring rate matching resources for the purpose of rate matching of a communication system will be described. Rate matching means that the size of a signal is adjusted in consideration of the amount of resources capable of transmitting the signal. For example, the rate matching of a data channel may mean that the size of data is adjusted without mapping and transmitting the data channel for a specific time and frequency resource area.

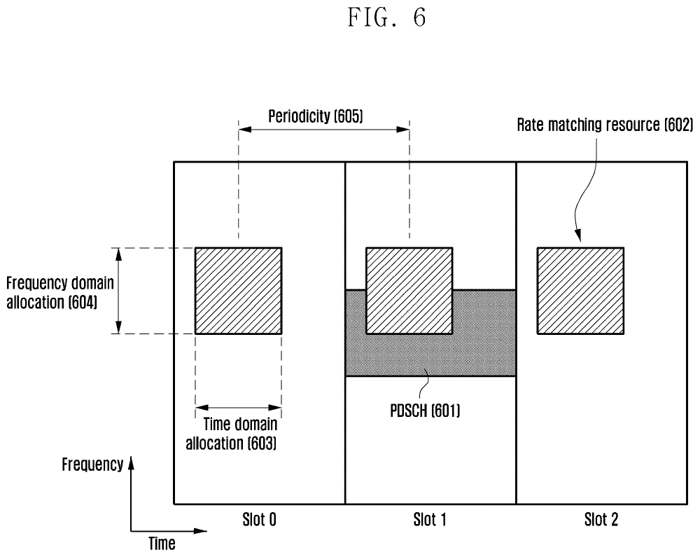

FIG. 6 illustrates a method in which a base station and a UE perform data transmission/reception by considering a downlink data channel and a rate matching resource.

In FIG. 6, a downlink data channel (PDSCH) 601 and a rate matching resource 602 are shown. The base station may configure one or more rate matching resources 602 in the UE through higher layer signaling (e.g., RRC signaling). The configuration information of the rate matching resource 602 may include time-domain resource allocation information 603, frequency-domain resource allocation information 604, and periodicity information 605. In the following description, a bitmap corresponding to the frequency-domain resource allocation information 604 is called a “first bitmap,” a bitmap corresponding to the time-domain resource allocation information 603 is called a “second bitmap,” and a bitmap corresponding to the periodicity information 605 is called a “third bitmap.” If some or all of the time and frequency resources of the scheduled data channel 601 overlap with the configured rate matching resource 602, the base station may rate-match and transmit the data channel 601 in the rate matching resource 602. The UE may perform data reception and decoding after assuming that the data channel 601 has been rate-matched in the rate matching resource 602.

The base station may dynamically notify the UE of whether the data channel may be rate-matched in the configured rate matching resource via DCI through an additional configuration (corresponding to a “rate matching indicator” in the DCI format described above). Specifically, the base station may select some of the configured rate matching resources, may group the selected resources into a rate matching resource group, and may indicate whether the data channel has been rate-matched with each rate matching resource group through DCI using a bitmap method to the UE. For example, when four rate matching resources RMR #1, RMR #2, RMR #3 and RMR #4 have been configured, the base station may configure RMG #1={RMR #1, RMR #2} and RMG #2={RMR #3, RMR #4} as rate matching groups, and may indicate whether rate matching in each of RMG #1 and RMG #2 has been performed using 2 bits of a DCI field to the UE in the form of a bitmap. For example, the base station may indicate “1” if rate matching needs to be performed, and may indicate “0” if rate matching does not need to be performed.

The 5G supports the granularity of “RB symbol level” and “RE level” as a method for configuring the above-described rate matching resource in the UE. Specifically, the configuration method described below may be followed.

The UE may be configured with up to four RateMatchPatterns for each BWP via higher layer signaling, and one RateMatchPattern may include the following contents.

A reserved resource in the BWP may include a resource, in which a time and frequency resource region of the corresponding reserved resource is configured as a combination of an RB-level bitmap and a symbol-level bitmap on the frequency axis. The reserved resource may span over one or two slots. The UE may be additionally configured with a time-domain pattern (periodicityAndPattern) in which the time and frequency domain including a pair of RB level and symbol level bitmaps are repeated.

A time and frequency domain resource region configured as a CORESET in the BWP and a resource region corresponding to a time-domain pattern configured as a search space configuration in which the resource region is repeated may be included.

The UE may be configured with the following information through higher layer signaling.

The number of ports (nrofCRS-Ports) and LTE-CRS-vshift(s) value (v-shift) of LTE CRS as configuration information (lte-CRS-ToMatchAround) for RE corresponding to an LTE cell-specific reference signal or common reference signal (CRS) pattern, center subcarrier location information (carrierFreqDL) of an LTE carrier from the reference frequency point (e.g., reference point A), the bandwidth size (carrierBandwidthDL) information of the LTE carrier, subframe configuration information (mbsfn-SubframConfigList) corresponding to a multicast-broadcast single-frequency network (MBSFN), and the like may be included. The UE may determine the location of the CRS in the NR slot corresponding to the LTE subframe based on the above-described information.

Configuration information for a resource set corresponding to one or multiple zero power (ZP) CSI-RSs in the bandwidth part may be included.

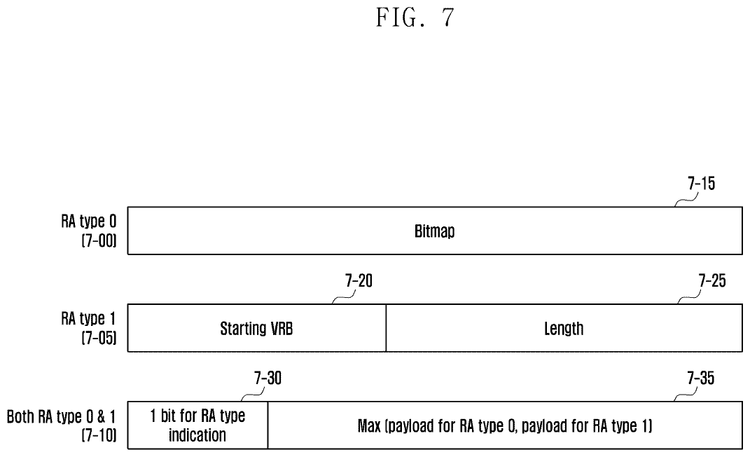

FIG. 7 illustrates an example of frequency-domain resource allocation of a physical downlink shared channel (PDSCH) or a physical uplink shared channel (PUSCH) in a wireless communication system according to an embodiment of the disclosure.

FIG. 7 shows three frequency-domain resource allocation methods of type 0 (7-00), type 1 (7-05), and dynamic switch (7-10) configurable through a higher layer in an NR wireless communication system.

With reference to FIG. 7, if a UE is configured to use only resource type 0 via higher layer signaling (7-00), some downlink control information (DCI) for allocation of PDSCH to the corresponding UE includes a bitmap formed of NRBG bits. The conditions for this will be described again later. Here, NRBG denotes the number of resource block groups (RBGs) determined, as in Table 11 below, according to a BWP size allocated by a BWP indicator and a higher layer parameter rbg-Size, and data is transmitted to RBG indicated as “1” in the bitmap.

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the UE is configured to use only resource type 1 via higher layer signaling (7-05), some DCI for allocation of the PDSCH to the UE includes frequency-domain resource allocation information configured by ┌log₂(N_{RB}^{DL,BWP}(N_{RB}^{DL,BWP}+1)/2┐ bits. The conditions for this will be described again later. Through this, the base station may configure a starting VRB 7-20 and the length of frequency-domain resources 7-25 continuously allocated therefrom.

If the UE is configured to use both resource type 0 and resource type 1 via higher layer signaling (7-10), some DCI for allocation of PDSCH to the UE includes frequency-domain resource allocation information configured by bits of a greater value 7-35 among a payload 7-15 for configuration of resource type 0 and payloads 7-20 and 7-25 for configuration of resource type 1. The conditions for this will be described again later. Here, one bit is added to the most significant bit (MSB) of the frequency-domain resource allocation information in the DCI, if the corresponding bit has a value of “0,” the bit indicates that resource type 0 is used, and if the corresponding bit has a value of “1,” the bit indicates that resource type 1 is used.

Hereinafter, a method for allocating time domain resources for a data channel in a next-generation mobile communication system (5G or NR system) will be described.

The base station may configure, for the UE, a table for time-domain resource allocation information for a physical downlink shared channel (PDSCH) and a physical uplink shared channel (PUSCH) via higher layer signaling (e.g., RRC signaling). For PDSCH, a table including maxNrofDL-Allocations=16 entries may be configured, and for PUSCH, a table including maxNrofUL-Allocations=16 entries may be configured. In an embodiment, the time-domain resource allocation information may include PDCCH-to-PDSCH slot timing (corresponding to a time interval in slot units between a time point at which a PDCCH is received and a time point at which a PDSCH scheduled by the received PDCCH is transmitted, and denoted by K0), PDCCH-to-PUSCH slot timing (corresponding to a time interval in slot units between a time point at which a PDCCH is received and a time point at which a PUSCH scheduled by the received PDCCH is transmitted, and denoted by K2), information on the position and length of a start symbol in which the PDSCH or PUSCH is scheduled within a slot, a mapping type of PDSCH or PUSCH, and the like. For example, information such as Table 12 or Table 13 below may be transmitted from the base station to the UE.

TABLE 12
PDSCH-TimeDomainResourceAllocationList information element
PDSCH-TimeDomainResourceAllocationList ::= SEQUENCE (SIZE(1..maxNrofDL-
Allocations)) OF PDSCH-TimeDomainResourceAllocation
PDSCH-TimeDomainResourceAllocation ::= SEQUENCE {
k0 INTEGER(0..32) OPTIONAL, -- Need S
(PDCCH-to-PDSCH timing, slot unit)
mappingType ENUMERATED {typeA, typeB},
(PDSCH mapping type)
startSymbolAndLength INTEGER (0..127)
(Start symbol and length of PDSCH)
}

TABLE 13
PUSCH-TimeDomainResourceAllocation information element
PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {
k2 INTEGER(0..32) OPTIONAL, -- Need S
(PDCCH-to-PUSCH timing, slot unit)
mappingType ENUMERATED {typeA, typeB},
(PUSCH mapping type)
startSymbolAndLength INTEGER (0..127)
(Start symbol and length of PUSCH)
}

The base station may notify one of the entries in the above-described table representing the time-domain resource allocation information to the UE via L1 signaling (e.g., DCI) (e.g., may be indicated by a “time-domain resource allocation” field in DCI). The UE may acquire time-domain resource allocation information for the PDSCH or PUSCH based on the DCI received from the base station.

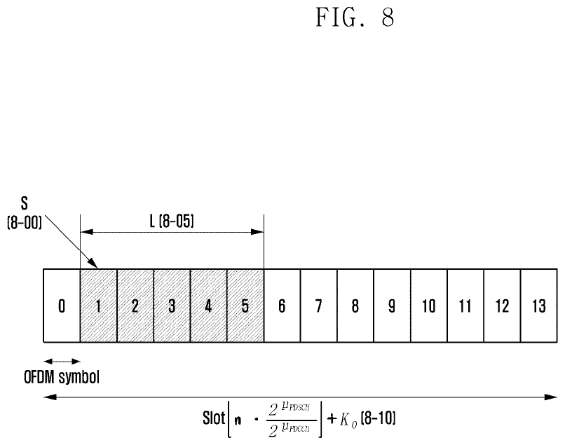

FIG. 8 illustrates an example of time-domain resource allocation of a PDSCH in a wireless communication system according to an embodiment of the disclosure.

With reference to FIG. 8, the base station may indicate a time-domain position of a PDSCH resource according to the subcarrier spacings (SCSs) (μ_{PDSCH}, μ_{PDCCH}) of a data channel and a control channel and a scheduling offset (K0) value configured using a higher layer, and a start position 8-00 and a length 8-05 of an OFDM symbol in one slot dynamically indicated via DCI.

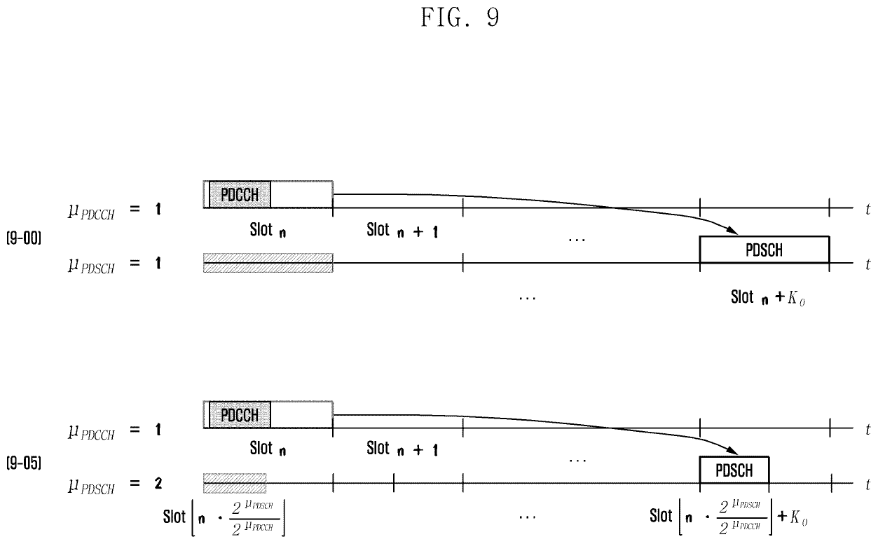

FIG. 9 illustrates an example of time-domain resource allocation based on subcarrier spacings of a data channel and a control channel in a wireless communication system according to an embodiment of the disclosure.

With reference to FIG. 9, in the case 9-00 where the data channel and the control channel have the same subcarrier spacing (μ_{PDSCH}=μ_{PDCCH}), the slot numbers for data and control are the same, so that the base station and the UE may generate a scheduling offset in accordance with a predetermined slot offset K0. On the other hand, in the case 9-05 where the data channel and the control channel have different subcarrier spacings (μ_{PDSCH}/μ_{PDCCH}), the slot numbers for data and control are different, so that the base station and the UE may generate a scheduling offset in accordance with a predetermined slot offset K0 based on the subcarrier spacing of the PDCCH.

Next, a scheduling scheme of PUSCH transmission will be described. The PUSCH transmission may be dynamically scheduled by a UL grant in DCI or may be operated by a configured grant Type 1 or Type 2. Dynamic scheduling indication for PUSCH transmission is possible using DCI format 0_0 or 0_1.

Configured grant Type 1 PUSCH transmission does not receive a UL grant in DCI and may be semi-statically configured through reception of configuredGrantConfig including rrc-ConfiguredUplinkGrant of Table 14 via higher layer signaling. Configured grant Type 2 PUSCH transmission may be semi-persistently scheduled by UL grant in DCI after reception of configuredGrantConfig that does not include the rrc-ConfiguredUplinkGrant of Table 14 via higher layer signaling. When PUSCH transmission is operated by a configured grant, parameters applied to PUSCH transmission are applied through configuredGrantConfig, which is higher layer signaling of Table 14, except for dataScramblingIdentityPUSCH, txConfig, codebookSubset, maxRank, and scaling of UCI-OnPUSCH, which are provided by pusch-Config of Table 15, which is higher layer signaling. If the UE is provided with transformPrecoder in configuredGrantConfig, which is higher layer signaling of Table 14, the UE applies tp-pi2BPSK in the pusch-Config of Table 15 with regards to PUSCH transmission operated by the configured grant.

TABLE 14
ConfiguredGrantConfig ::= SEQUENCE {

| | |
|---|---|
| frequencyHopping ENUMERATED {intraSlot, interSlot} | OPTIONAL, -- Need S, |

cg-DMRS-Configuration DMRS-UplinkConfig,

| | |
|---|---|
| mcs-Table ENUMERATED {qam256, qam64LowSE} | OPTIONAL, -- Need S |

mcs-TableTransformPrecoder ENUMERATED {qam256, qam64LowSE} OPTIONAL,
-- Need S

| | |
|---|---|
| uci-OnPUSCH SetupRelease { CG-UCI-OnPUSCH } | OPTIONAL, -- Need M |

resourceAllocation ENUMERATED { resourceAllocationType0, resourceAllocationType1,
dynamicSwitch },

| | |
|---|---|
| rbg-Size ENUMERATED { config2} | OPTIONAL, -- Need S |

```
  powerControlLoopToUse ENUMERATED {n0, n1},
  p0-PUSCH-Alpha P0-PUSCH-AlphaSetId,
```

| | |
|---|---|
| transformPrecoder ENUMERATED {enabled, disabled } | OPTIONAL, -- Need S |

```
  nrofHARQ-Processes INTEGER(1..16),
  repK ENUMERATED {n1, n2, n4, n8},
```

| | |
|---|---|
| repK-RV ENUMERATED {s1-0231, s2-0303, s3-0000} | OPTIONAL, -- Need R |

```
  periodicity ENUMERATED {
      sym2, sym7, sym1x14, sym2x14, sym4x14, sym5x14, sym8x14, sym10x14, sym16x14,
sym20x14,
      sym32x14, sym40x14, sym64x14, sym80x14, sym128x14, sym160x14, sym256x14,
sym320x14, sym512x14,
      sym640x14, sym1024x14, sym1280x14, sym2560x14, sym5120x14,
      sym6, sym1x12, sym2x12, sym4x12, sym5x12, sym8x12, sym10x12, sym16x12,
sym20x12, sym32x12,
      sym40x12, sym64x12, sym80x12, sym128x12, sym160x12, sym256x12, sym320x12,
sym512x12, sym640x12,
      sym1280x12, sym2560x12
  },
```

| | |
|---|---|
| configuredGrantTimer INTEGER (1..64) | OPTIONAL, -- Need R |

```
  rrc-ConfiguredUplinkGrant SEQUENCE {
    timeDomainOffset INTEGER (0..5119),
    timeDomainAllocation INTEGER (0..15),
    frequencyDomainAllocation BIT STRING (SIZE(18)),
    antennaPort INTEGER (0..31),
```

| | |
|---|---|
| dmrs-SeqInitialization INTEGER (0..1) | OPTIONAL, -- Need R |

precodingAndNumberOfLayers INTEGER (0..63),

| | |
|---|---|
| srs-ResourceIndicator INTEGER (0..15) | OPTIONAL, -- Need R |

```
    mcsAndTBS INTEGER (0..31),
    frequencyHoppingOffset INTEGER (1..maxNrofPhysicalResourceBlocks-1) OPTIONAL,
-- Need R
    pathlossReferenceIndex INTEGER (0..maxNrofPUSCH-PathlossReferenceRSs-1),
    ...
  } OPTIONAL, -- Need R
  ...
}
```

Next, a PUSCH transmission method will be described. A DMRS antenna port for PUSCH transmission is the same as an antenna port for SRS transmission. PUSCH transmission may be based on a codebook-based transmission method and a non-codebook-based transmission method, respectively, depending on whether the value of txConfig in pusch-Config of Table 15, which is higher layer signaling, is “codebook” or “nonCodebook.”

As described above, the PUSCH transmission may be dynamically scheduled through DCI format 0_0 or 0_1, and may be semi-statically configured by a configured grant. If the UE is indicated to schedule PUSCH transmission through DCI format 0_0, the UE performs beam configuration for PUSCH transmission by using pucch-spatialRelationInfoID corresponding to the UE-specific PUCCH resource corresponding to the minimum ID in the uplink BWP activated in the serving cell, and here, PUSCH transmission is based on a single antenna port. The UE does not expect scheduling for PUSCH transmission through DCI format 00 within a BWP in which the PUCCH resource including the pucch-spatialRelationInfo is not configured. If the UE is not configured with txConfig in pusch-Config of Table 15, the UE does not expect to be scheduled in DCI format 0_1.

TABLE 15

| PUSCH-Config ::= | SEQUENCE { | |
|---|---|---|
| dataScramblingIdentityPUSCH | INTEGER (0..1023) | OPTIONAL, -- Need S |
| txConfig | ENUMERATED {codebook, nonCodebook} | OPTIONAL, -- Need S |

| | |
|---|---|
| dmrs-UplinkForPUSCH-Mapping TypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | | |
|---|---|---|
| pusch-PowerControl | PUSCH-PowerControl | OPTIONAL, -- Need M |
| frequencyHopping | ENUMERATED {intraSlot, interSlot} | OPTIONAL, -- Need |

S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| pusch-TimeDomainAllocationList | SetupRelease { PUSCH- | |
|---|---|---|
| TimeDomainResourceAllocationList } | OPTIONAL, -- Need M | |
| pusch-AggregationFactor | ENUMERATED { n2, n4, n8 } | OPTIONAL, -- Need |

S

| | | |
|---|---|---|
| mcs-Table | ENUMERATED {qam256, qam64LowSE} | OPTIONAL, -- Need |

S

| | |
|---|---|
| mcs-TableTransformPrecoder | ENUMERATED {qam256, qam64LowSE} |

OPTIONAL, -- Need S

| | | |
|---|---|---|
| transformPrecoder | ENUMERATED {enabled, disabled} | OPTIONAL, -- Need |

S

| | |
|---|---|
| codebookSubset | ENUMERATED {fullyAndPartialAndNonCoherent, |

partialAndNonCoherent,nonCoherent}

| | OPTIONAL, -- Cond codebookBased | |
|---|---|---|
| maxRank | INTEGER (1..4) | OPTIONAL, -- Cond codebookBased |
| rbg-Size | ENUMERATED { config2} | OPTIONAL, -- Need S |
| uci-OnPUSCH | SetupRelease { UCI-OnPUSCH} | OPTIONAL, -- Need M |
| tp-pi2BPSK | ENUMERATED {enabled} | OPTIONAL, -- Need S |

```
    ...
  }
```

Next, codebook-based PUSCH transmission will be described. The codebook-based PUSCH transmission may be dynamically scheduled through DCI format 0_0 or 0_1, and may operate semi-statically by a configured grant. When the codebook-based PUSCH is dynamically scheduled by DCI format 0_1 or is configured semi-statically by a configured grant, the UE determines a precoder for PUSCH transmission based on an SRS resource indicator (SRI), a transmission precoding matrix indicator (TPMI), and a transmission rank (the number of PUSCH transport layers).

Here, the SRI may be given through a field SRS resource indicator in DCI or may be configured through srs-ResourceIndicator, which is higher layer signaling. The UE is configured with at least one SRS resource when transmitting a codebook-based PUSCH, and may be configured with up to two SRS resources. When the UE is provided with an SRI through DCI, the SRS resource indicated by the corresponding SRI denotes an SRS resource corresponding to the SRI among SRS resources transmitted before the PDCCH including the corresponding SRI. In addition, TPMI and transmission rank may be given through field precoding information and number of layers in DCI, or may be configured through precodingAndNumberOfLayers, which is higher layer signaling. TPMI is used to indicate a precoder applied to PUSCH transmission. If the UE is configured with one SRS resource, the TPMI is used to indicate a precoder to be applied in the configured one SRS resource. If the UE is configured with multiple SRS resources, the TPMI is used to indicate a precoder to be applied in the SRS resource indicated through the SRI.

A precoder to be used for PUSCH transmission is selected from an uplink codebook having the same number of antenna ports as the value of nrofSRS-Ports in SRS-Config, which is higher layer signaling. In codebook-based PUSCH transmission, the UE determines a codebook subset based on the TPMI and codebookSubset in pusch-Config, which is higher layer signaling. CodebookSubset in pusch-Config, which is higher layer signaling, may be configured with one of “fullyAndPartialAndNonCoherent,” “partialAndNonCoherent,” or “nonCoherent” based on the UE capability reported by the UE to the base station. If the UE reports “partialAndNonCoherent” as UE capability, the UE does not expect that the value of codebookSubset, which is higher layer signaling, is configured to be “fullyAndPartialAndNonCoherent.” In addition, if the UE reports “nonCoherent” as UE capability, the UE does not expect that the value of codebookSubset, which is higher layer signaling, is configured to be “fullyAndPartialAndNonCoherent” or “partialAndNonCoherent.” When nrofSRS-Ports in SRS-ResourceSet, which is higher layer signaling, indicates two SRS antenna ports, the UE does not expect that the value of codebookSubset, which is higher layer signaling, is configured to be “partialAndNonCoherent.”

The UE may be configured with one SRS resource set in which the value of usage in the SRS-ResourceSet, which is higher layer signaling, is configured to be “codebook,” and one SRS resource in the corresponding SRS resource set may be indicated through SRI. If multiple SRS resources are configured in the SRS resource set in which the usage value in the SRS-ResourceSet, which is higher layer signaling, is configured to be “codebook,” the UE expects that the values of nrofSRS-Ports in the SRS-Resource, which is higher layer signaling, are configured to be the same value with respect to all SRS resources.

The UE transmits, to the base station, one or multiple SRS resources included in the SRS resource set in which the value of usage is configured to be “codebook” according to higher layer signaling, and the base station indicates the UE to perform PUSCH transmission by selecting one of the SRS resources transmitted by the UE and using transmission beam information of the corresponding SRS resource. Here, in the codebook-based PUSCH transmission, the SRI is used as information for selection of the index of one SRS resource and is included in the DCI. Additionally, the base station includes, in the DCI, information indicating a rank and a TPMI to be used by the UE for PUSCH transmission. The UE performs PUSCH transmission by using the SRS resource indicated by the SRI and applying a rank indicated based on the transmission beam of the SRS resource and a precoder indicated by the TPMI.

Next, non-codebook-based PUSCH transmission will be described. Non-codebook-based PUSCH transmission may be dynamically scheduled through DCI format 0_0 or 0_1, and may be semi-statically operated by a configured grant. When at least one SRS resource is configured in the SRS resource set in which the value of usage in the SRS-ResourceSet, which is higher layer signaling, is configured to be “nonCodebook,” the UE may be scheduled with non-codebook-based PUSCH transmission through DCI format 0_1.

For the SRS resource set in which the value of usage in the SRS-ResourceSet, which is higher layer signaling, is configured to be “nonCodebook,” the UE may be configured with one connected non-zero power CSI-RS (NZP CSI-RS) resource. The UE may perform calculation of the precoder for SRS transmission by measuring the NZP CSI-RS resource connected to the SRS resource set. If the difference between the last received symbol of the aperiodic NZP CSI-RS resource connected to the SRS resource set and the first symbol of aperiodic SRS transmission in the UE is less than 42 symbols, the UE does not expect information on the precoder for SRS transmission to be updated.

When the value of resourceType in the SRS-ResourceSet, which is higher layer signaling, is configured to be “aperiodic,” the connected NZP CSI-RS is indicated by SRS request, which is a field in DCI format 0_1 or 1_1. Here, if the connected NZP CSI-RS resource is an aperiodic NZP CSI-RS resource, the connected NZP CSI-RS exists when the value of the SRS request field in DCI format 0_1 or 1_1 is not “00.” In this case, the DCI may not indicate cross carrier or cross BWP scheduling. In addition, if the value of the SRS request indicates the existence of the NZP CSI-RS, the corresponding NZP CSI-RS is located in a slot in which a PDCCH including the SRS request field is transmitted. Here, TCI states configured via the scheduled subcarrier are not configured to be QCL-TypeD.

If a periodic or semi-persistent SRS resource set is configured, the connected NZP CSI-RS may be indicated through associated CSI-RS in the SRS-ResourceSet, which is higher layer signaling. For non-codebook-based transmission, the UE does not expect that spatialRelation Info, which is higher layer signaling for SRS resource, and associated CSI-RS in SRS-ResourceSet, which is higher layer signaling, are configured together.

When the UE is configured with multiple SRS resources, the UE may determine a precoder to be applied to PUSCH transmission and a transmission rank, based on the SRI indicated by the base station. Here, the SRI may be indicated through a field SRS resource indicator in DCI or may be configured through srs-ResourceIndicator, which is higher layer signaling. As in the above-described codebook-based PUSCH transmission, when the UE is provided with an SRI through DCI, an SRS resource indicated by the SRI denotes an SRS resource corresponding to the SRI among SRS resources transmitted before the PDCCH including the SRI. The UE may use one or multiple SRS resources for SRS transmission, and the maximum number of SRS resources that can be simultaneously transmitted in the same symbol in one SRS resource set are determined by UE capability reported by the UE to the base station. Here, the SRS resources simultaneously transmitted by the UE occupy the same RB. The UE configures one SRS port for each SRS resource. Only one SRS resource set in which the value of usage in the SRS-ResourceSet, which is higher layer signaling, is configured to be “nonCodebook” can be configured, and up to four SRS resources for non-codebook-based PUSCH transmission can be configured.

The base station transmits one NZP-CSI-RS connected to the SRS resource set to the UE, and the UE performs calculation of a precoder to be used for transmission of one or multiple SRS resources in the corresponding SRS resource set based on a result of measurement at the time of reception of the NZP-CSI-RS. The UE applies, to the base station, the calculated precoder when transmitting one or multiple SRS resources in the SRS resource set in which usage is configured to be “nonCodebook,” and the base station selects one or multiple SRS resources among the received one or multiple SRS resources. In this case, in non-codebook-based PUSCH transmission, the SRI indicates an index capable of expressing one or a combination of multiple SRS resources, and the SRI is included in the DCI. Here, the number of SRS resources indicated by the SRI transmitted by the base station may be the number of transmission layers of the PUSCH, and the UE performs PUSCH transmission by applying a precoder applied for SRS resource transmission to each layer.

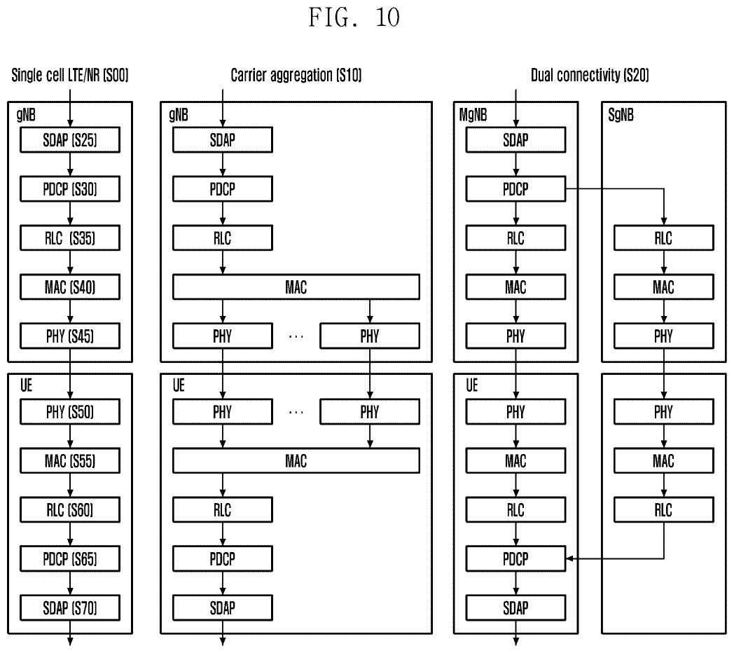

FIG. 10 illustrates radio protocol structures of a base station and a UE in single cell, carrier aggregation, and dual connectivity situations in a wireless communication system according to an embodiment of the disclosure.

With reference to FIG. 10, the radio protocol of the next generation mobile communication system includes, for each of a UE and an NR base station, NR service data adaptation protocols (NR SDAPs) S25 and S70, NR packet data convergence protocols (NR PDCPs) S30 and S65, NR radio link controls (NR RLCs) S35 and S60, and NR medium access control (NR MACs) S40 and S55.

The functions of the NR SPAPs S25 and S70 may include some of the following functions:
Transfer of user plane data;
Mapping between a quality of service (QoS) flow and a data bearer (DRB) for both DL and UL;
Marking QoS flow ID in both DL and UL packets; and/or
Reflective QoS flow to DRB mapping for the UL SDAP PDUs.

For the SDAP layer device, the UE may be configured, via an RRC message, about whether to use a header of the SDAP layer device or whether to use a function of the SDAP layer device, according to each PDCP layer device, each bearer, or each logical channel. If the SDAP header is configured, the UE may be indicated by a one-bit NAS reflective QoS indicator (NAS reflective QoS) and a one-bit AS reflective QoS indicator (AS reflective QoS) of the SDAP header to update or reconfigure mapping information between a data bearer and a QoS flow of uplink and downlink. The SDAP header may include QoS flow ID information indicating QoS. The QoS information may be used as a data processing priority for supporting smooth services, scheduling information, or the like.

The functions of the NR PDCPs S30 and S65 may include some of the following functions:
Header compression and decompression: robust header compression (ROHC) only;
Transfer of user data;
In-sequence delivery of higher layer PDUs;
Out-of-sequence delivery of higher layer PDUs;
PDCP PDU reordering for reception;
Duplicate detection of lower layer service data units (SDUs);
Retransmission of PDCP SDUs;
Ciphering and deciphering; and/or
Timer-based SDU discard in uplink.

In the above, a reordering function of the NR PDCP device refers to a function of sequentially reordering PDCP PDUs, received from a lower layer, based on a PDCP sequence number (SN), and may include a function of transmitting data to a higher layer in the sequence of reordering. Alternatively, the reordering function of the NR PDCP device may include a function of transmitting data without considering the sequence, a function of reordering the sequence and recording missing PDCP PDUs, a function of providing a state report on the missing PDCP PDUs to a transmission side, and a function of requesting retransmission for the missing PDCP PDUs.

The functions of the NR RLCs S35 and S60 may include some of the following functions:
Transfer of higher layer PDUs;
In-sequence delivery of higher layer PDUs;
Out-of-sequence delivery of higher layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

The in-sequence delivery function of the NR RLC device refers to a function of transmitting RLC SDUs, received from a lower layer, to a higher layer in the sequence of reception. The in-sequence delivery function of the NR RLC device may include a function of, if originally one RLC SDU is segmented into multiple RLC SDUs and received, reassembling and transmitting the multiple RLC SDUs, a function of reordering the received RLC PDUs based on an RLC SN or PDCP SN, a function of reordering the sequence and recording missing RLC PDUs, a function of providing a state report on the missing RLC PDUs to a transmission side, and a function of requesting retransmission for the missing RLC PDUs. If the missing RLC SDU occurs, the in-sequence delivery function of the NR RLC device may include a function of sequentially transmitting only the RLC SDUs prior to the missing RLC SDU to a higher layer or sequentially transmitting all the RLC SDUs received before a timer starts to a higher layer if a predetermined timer expires although there is a missing RLC SDU. Alternatively, the in-sequence delivery function of the NR RLC device may include a function of sequentially transmitting all RLC SDUs received so far to a higher layer if a predetermined timer expires although there is a missing RLC SDU. In addition, the RLC PDUs may be processed in the sequence that the RLC PDUS are received (in the sequence of arrival regardless of the sequence of serial number and sequence number), and may be transmitted to a PDCP device out of sequence delivery. In a case of segments, the in-sequence delivery function may include a function of receiving segments stored in a buffer or segments to be received later, reconfiguring the segments in one complete RLC PDU, processing the RLC PDU, and transmitting the RLC PDU to the PDCP device. The NR RLC layer may not include a concatenation function, and the concatenation function may be performed by the NR MAC layer or may be replaced by a multiplexing function of the NR MAC layer.

In the above, the out-of-sequence delivery function of the NR RLC device refers to a function of directly transmitting the RLC SDUs, received from the lower layer, to a higher layer regardless of the order, and may include, if originally one RLC SDU is segmented into multiple RLC SDUs and received, a function of reassembling the multiple RLC SDUs and transmitting the same, and a function of storing the RLC SNs or PDCP SNs of the received RLC PDUs, reordering the sequence, and recording the missing RLC PDUs.

The NR MACs S40 and S55 may be connected to multiple NR RLC layer devices configured in one UE, and functions of the NR MAC may include some of the following functions:
Mapping between logical channels and transport channels;
Multiplexing/de-multiplexing of MAC SDUs;
Scheduling information reporting;
Error correction through HARQ;
Priority handling between logical channels of one UE;
Priority handling between UEs by means of dynamic scheduling;
Multimedia broadcast service (MBMS) identification;
Transport format selection; and/or
Padding.

The NR PHY layers S45 and S50 may perform an operation of channel-coding and modulating higher layer data, generating the higher layer data into an OFDM symbol, transmitting the OFDM symbols via a radio channel, or demodulating and channel decoding of the OFDM symbols received via the radio channel, and transferring the OFDM symbol to a higher layer.

The detailed structure of the above-described radio protocol structure may be variously changed according to a carrier (or cell) management method. For example, when the base station performs single carrier (or cell)-based data transmission to the UE, the base station and the UE use a protocol structure, which has a single structure for each layer, such as S00. On the other hand, when the base station transmits data to the UE based on carrier aggregation (CA) using multiple carriers in a single TRP, the base station and the UE has a single structure up to RLC but uses a protocol structure of multiplexing a PHY layer through a MAC layer, such as S10. As another example, when the base station transmits data to the UE based on dual connectivity (DC) using multiple carriers in multiple TRP, the base station and the UE have a single structure up to RLC, but use a protocol structure of multiplexing a PHY layer through a MAC layer, such as S20.

Hereinafter, the above examples will be described through a plurality of embodiments, but they are not independent, and such embodiments can be applied at the same time or in combination.

Hereinafter, embodiments of the disclosure will be described in detail with reference to the accompanying drawings. In the disclosure, the base station, as a subject performing resource allocation of a terminal, may be at least one of gNode B, gNB, eNode B, Node B, BS, radio access unit, base station controller, or node on a network. The terminal may include a UE, an MS, a cellular phone, a smartphone, a computer, or a multimedia system capable of performing a communication function. Hereinafter, an embodiment will be described using a 5G system as an example, but the embodiment may be applied to other communication systems having a similar technical background or channel type. For example, LTE or LTE-A mobile communication and mobile communication technology developed after 5G may be included therein. Accordingly, the embodiments may be applied to other communication systems through some modifications within a range that does not significantly depart from the scope of the disclosure as determined by those of ordinary skilled in the art. The contents of the disclosure are applicable to FDD and TDD systems.

In addition, in the description of the disclosure, if it is determined that a detailed description of a related function or configuration may unnecessarily obscure the subject matter of the disclosure, the detailed description thereof will be omitted. In addition, the terms to be described later are terms defined considering functions in the disclosure, which may vary according to intentions or customs of users and operators. Therefore, the definition should be made based on the entire description herein.

Hereinafter, higher layer signaling may be signaling corresponding to at least one or a combination of one or more of the following signaling:
Master information block (MIB);
System information block (SIB) or SIB X (X=1, 2, . . . );
Radio resource control (RRC); and/or
Medium access control (MAC) control element (CE).

In addition, L1 signaling may be signaling corresponding to at least one or a combination of one or more of signaling methods using the following physical layer channel or signaling:
Physical downlink control channel (PDCCH);
Downlink control information (DCI);
UE-specific DCI;
Group common DCI;
Common DCI;
Scheduling DCI (for example, DCI used for scheduling downlink or uplink data);
Non-scheduling DCI (for example, DCI not for the purpose of scheduling downlink or uplink data);
Physical uplink control channel (PUCCH); and/or
Uplink control information (UCI).

In the disclosure, determining a priority between A and B refers to selecting one having a higher priority according to a predetermined priority rule to perform an operation corresponding thereto or omitting (or dropping) an operation for the other one having a lower priority.

In the following description, the above examples will be described through a plurality of embodiments, but they are not independent, and such embodiments can be applied at the same time or in combination.

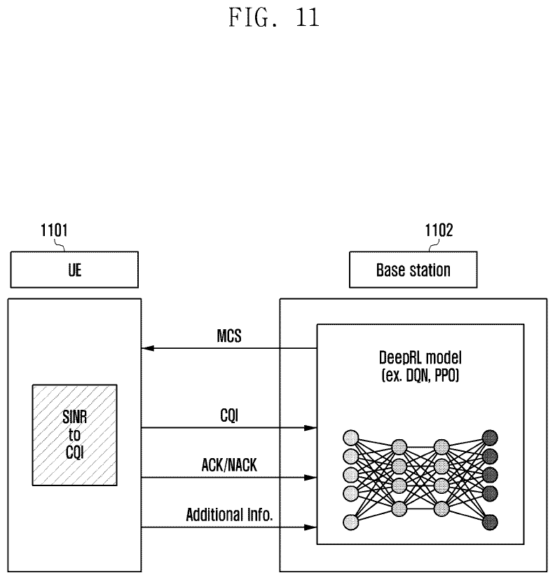

FIG. 11 illustrates an example of a link adaptation (LA) structure using artificial intelligence (AI) according to an embodiment of the disclosure.

According to an embodiment, the link adaptation may correspond to a technology for selecting an MCS having the optimal transfer rate depending on a varying radio environment in order to solve problems due to network congestion, signal interference, and dynamic changes in network conditions.

According to an embodiment, as one of link adaptation techniques, outer loop link adaptation (OLLA) is a method in which the base station checks whether the UE has successfully decoded each downlink data from feedback for each downlink data channel together with CQI information reported from the UE to the base station, and determines an MCS suitable for the downlink data by accumulating the checking results.

In relation to FIG. 11, an embodiment of an AI link adaptation technology or model may include deep reinforcement learning (deepRL), Thompson sampling, distributional reinforcement learning, proximal policy optimization (PPO), implicit quantile network (IQN), deep Q-network (DQN), or other technologies or algorithms related to reinforcement learning.

In relation to an embodiment, the deep reinforcement learning is a field of reinforcement learning that learns which choice is optimal through trial and error and learning proceeds in the direction of maximizing reward, and may correspond to a technology that handles complex and high-dimensional inputs and outputs using deep learning technology. In addition, it may learn using a deep neural network. A related example may be a DQN algorithm to which deep learning and reinforcement learning are applied.

In relation to an embodiment, the Thompson sampling may be related to Bayesian inference and is an algorithm that probabilistically finds the optimal choice by considering uncertainty. It may be applied to the multi-armed bandit problem of reinforcement learning.

In relation to an embodiment, the distributional reinforcement learning is an algorithm that performs reinforcement learning by modeling the return value as a probability distribution. Unlike expected value-centered reinforcement learning, it can handle uncertainty.

In relation to an embodiment, the proximal policy optimization (PPO) may correspond to a reinforcement learning algorithm that learns stably by updating the policy.

In relation to an embodiment, the implicit quantile network (IQN) is a reinforcement learning algorithm that handles uncertainty by utilizing a quantile function, and can be applied to the distributional reinforcement learning. In addition, the DQN may correspond to a reinforcement learning algorithm that approximates the Q function using a deep neural network.

In FIG. 11, based on a determined modulation and coding scheme (MCS) configuration, a user equipment (UE) 1101 may transmit, to a base station 1102, a channel quality indicator (CQI) in which information related to channel quality according to channel quality measurement can be included, UE's feedback information (hybrid automatic repeat request (HARQ) feedback), and the like. The base station 1102 may additionally obtain information related to a channel state of the UE 1101, such as a rank indicator (RI), channel state information interference measurement (CSI-IM), and a signal to interference plus noise ratio (SINR). The above information may be input data of the base station 1102.

According to an embodiment, the base station 1102 may obtain information or data related to a channel state or quality from the UE 1101, and may use this information or data for the AI link adaptation technology or model, etc. In addition, based on this information or data, the base station 1102 may obtain information related to spectrum efficiency, information for MCS selection, etc.

According to an embodiment, from HARQ feedback for each downlink data channel together with CQI information reported from the UE 1101 to the base station 1102, the base station 1102 can check whether the UE 1101 has successfully decoded each downlink data channel packet, and accumulate the results to perform an operation of converging the error rate for the downlink data channel to a certain value predetermined by the base station 1102.

According to an embodiment, there is a difference in the UPT(user perceived throughput) gain in accordance to traffic amount, and a loss may occur at relatively low traffic. So, according to an embodiment, by performing more link adaptation (e.g., OLLA or PPO-LA) using more data, faster MCS convergence is possible, and traffic transmission can be completed quickly, so a high UPT gain can be secured.

According to an embodiment, when the packet size is large and there is a time interval from the previous traffic, the process of link adaptation becomes slow and throughput degradation occurs. In addition, due to a lack of time-continuous traffic, the base station's input (e.g., HARQ feedback, etc.) may become insufficient, which may result in a situation where link adaptation cannot be performed or is difficult to perform while there is no traffic. In addition, due to a small amount of data packets, a time delay may occur until an appropriate MCS is selected.

As such, AI communication technology trained using collected data may have a problem of being biased toward UEs with a large amount of data, so it is necessary to maintain communication between the UE and the base station at a constant level.

According to an embodiment, an example in which a relatively high MCS selection occurs when an additional preconfigured PDSCH is transmitted compared to when the base station only uses real traffic (i.e., does not transmit an additional preconfigured PDSCH).

According to an embodiment, the preconfigured PDSCH may be defined as a PDSCH configured for channel measurement or link adaptation by using a spare resource, a resource other than a resource for the existing PDSCH or a PDSCH for actual data transmission required for the UE, or a surplus resource.

The link adaptation may be link adaptation related to AI, and the preconfigured PDSCH may be utilized not only for the purpose of channel measurement, but also for the purpose of supporting other measurements or techniques that the base station may additionally perform by utilizing spare resources.

Specifically, it can be utilized when the base station needs a response from the UE in a certain environment, when the base station transmits a signal for a test to apply a specific model and needs a response, when feedback on other information is required, or the like.

According to an embodiment, using transmission of the preconfigured PDSCH, the base station can secure inputs such as data sets for link adaptation, scheduling, channel estimation, interference estimation, etc. without bias over time.

According to an embodiment, even the UE with relatively little traffic can transmit a similar amount of feedback (e.g., HARQ feedback) as the UE with relatively much traffic.

According to an embodiment, by securing a data set through the preconfigured PDSCH, it is possible to obtain sufficient opportunities to test for updating or applying an AI-based communication model (e.g., AI link adaptation), check model results, determine AI policy, or conduct related learning.

For example, the check for the model results may correspond to a check performed in the case where the current data trend or environment has changed when applying an AI model after the completion of learning, in the case where a certain amount of time has passed after the completion of learning, or in the case where the optimal risk management method or AI model may be selected in the current situation.

According to an embodiment, in the case of the UE with a long time interval between traffics, link adaptation may be performed more slowly than the UE with a relatively short time interval, or there may be difficulty of having to re-perform link adaptation that was being performed due to the long time interval. However, if the preconfigured PDSCH according to an embodiment is transmitted through a spare resource, the above problem can be solved and fast link adaptation can be performed.

According to an embodiment, the base station can start with an appropriate MCS from the beginning, so that fast data transmission can be completed, thereby securing a high UPT gain.

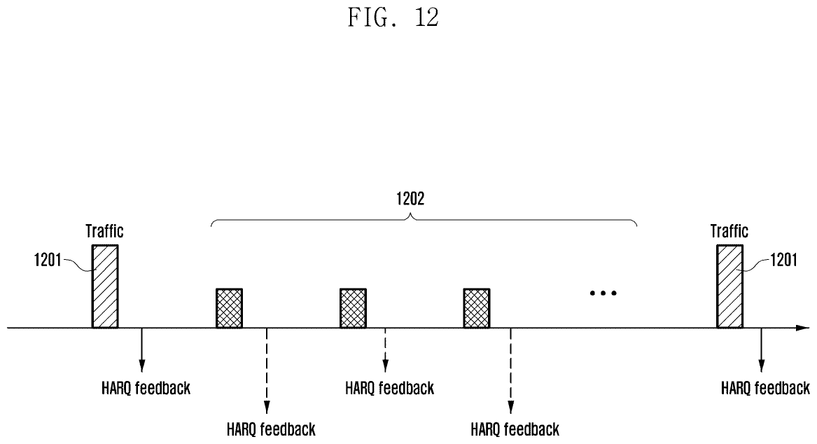

FIG. 12 illustrates an example of a process for transmitting a preconfigured PDSCH by utilizing spare resources according to an embodiment of the disclosure.

According to FIG. 12, in the graph illustrated with the time axis, 1201 indicates a PDSCH that actually transmits data required by the UE, and 1203 indicates a PDSCH preconfigured by the base station by utilizing spare resources.

In FIG. 12, if there is only the typical PDSCH 1201 for transmitting data without the preconfigured PDSCH, the base station can receive feedback (e.g., HARQ feedback) twice and perform link adaptation (e.g., OLLA or related algorithm) twice accordingly.

In FIG. 12, if the preconfigured PDSCH 1203 is used together with the typical PDSCH 1201 transmitting data, for example, if three preconfigured PDSCHs are used additionally between the typical PDSCHs 1201 as shown exemplarily, there may be three feedback and three link adaptation opportunities. Therefore, there may be a total of five feedback and five link adaptation opportunities. In addition, an offset (e.g., OLLA offset) related to link adaptation may be updated together with the feedback through each preconfigured PDSCH.

Through the preconfigured PDSCH 1202, the base station can maintain the SINR change or trend with the UE even if the traffic volume of the UE is small, and can additionally secure data for link adaptation, etc.

According to an embodiment, the preconfigured PDSCH may be defined as a PDSCH configured for channel measurement or link adaptation by using a spare resource, a resource other than a resource for the existing PDSCH or a PDSCH for actual data transmission required for the UE, or a surplus resource. In addition, the preconfigured PDSCH may correspond to a PDSCH that is not considered for retransmission even when the UE fails to receive or decode and sends feedback ofNACK. In addition, the preconfigured PDSCH may correspond to a PDSCH that transmits a preconfigured signal rather than data that the UE needs.

According to an embodiment, the preconfigured PDSCH may correspond to a PDSCH configured to obtain feedback on the case where the resulting MCS is applied for performance check related to a model such as AI inference.

According to an embodiment, the sequence of the preconfigured PDSCH may be a preconfigured sequence for determining whether decoding is successful or failed, and may be a sequence including information on allocated RB or MCS for this purpose.

According to an embodiment, the sequence of the preconfigured PDSCH may include information requesting data collection, information on required data, or information on the amount of required data.

According to an embodiment, the sequence of the preconfigured PDSCH is not limited to the configuration information described above, and may correspond to information for supporting other measurements or technologies that the base station can additionally perform by utilizing spare resources, or may be used to additionally transmit information that is only present in the base station to the UE.

According to an embodiment, in the case of successfully decoding the received preconfigured PDSCH, the UE transmits feedback such as ACK/NACK, as with other PDSCHs, but may not store a redundancy version (RV) for NACK.

According to an embodiment, the UE may perform decoding only for the preconfigured PDSCH, excluding the typical PDSCH that transmits data required by the UE, if necessary, and may not transmit HARQ feedback as necessary (e.g., when data is required for AI models, etc. at the UE).

According to an embodiment, the preconfigured PDSCH may be used for technologies related to channel measurement, etc. at both the UE and the base station, and may be used for data collection related to AI models. In other words, the PDSCH may be used when specific data is required at the UE, without being limited to technologies related to link adaptation at the base station.

According to an embodiment, the base station can perform performance checks related to models such as AI training, AI inference, etc. (for example, checks on performance evaluation indicators such as a block error rate (BLER) of the result value of link adaptation) through the preconfigured PDSCH, and can use information related to the models as input data for technologies related to link adaptation, or can correct an offset for link adaptation.

In addition, the base station may not include in the input data if the input date does not meet certain criteria, such as not satisfying the target performance-related indicators (such as BLER).

In addition, the base station may change and transmit the preconfigured PDSCH according to the MCS changed based on the SINR acquired or updated through feedback via the preconfigured PDSCH using spare resources, and may transmit a new preconfigured PDSCH based on new information.

According to an embodiment, as specific examples of using the preconfigured PDSCH, there may be a periodic transmission method, a semi-periodic transmission method, a method of configuring a specific RB for the preconfigured PDSCH, a transmission method based on PRB utilization, a transmission method based on a scheduling frequency, a transmission method based on a request of the UE or the base station, etc.

The periodic transmission method may correspond to a method of configuring the preconfigured PDSCH having a period denoted by N to spare resources. In addition, regardless of existing data, the preconfigured PDSCH may be transmitted every N slots or ms. In this case, if there is existing data, such data may be transmitted instead of the preconfigured PDSCH, and if there is no existing data, the preconfigured PDSCH may be transmitted.

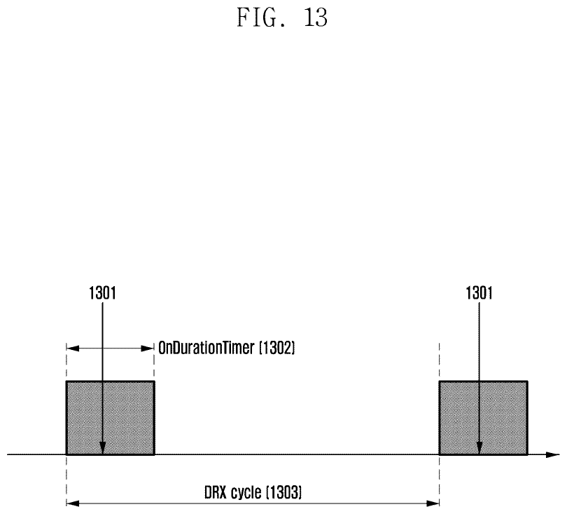

FIG. 13 illustrates an example of use in CDRX when a preconfigured PDSCH is transmitted using a periodic transmission method according to an embodiment of the disclosure.

According to FIG. 13, the periodic transmission method of the preconfigured PDSCH can be used together with discontinuous reception (DRX)/connected mode DRX (CDRX) technology for energy efficiency.

According to FIG. 13, 1301 corresponds to the preconfigured PDSCH that utilizes spare resources, 1302 corresponds to the OnDurationTimer which is a time for which the UE is kept active in CDRX, and 1303 corresponds to the DRX cycle which is a period between the start points of the OnDurationTimer.

In addition, the DRX cycle or the period in the periodic transmission method can operate using its maximum value.

In addition, in the case where a signal is received from the base station, a timer (e.g., a DRX inactivity timer) may be configured for a certain period of time until inactivation for additional reception. However, in the case where the preconfigured PDSCH according to an embodiment of the disclosure is received, the DRX inactivity timer may be configured not to be activated.

The semi-periodic transmission method may correspond to a method in which the base station transmits the preconfigured PDSCH in the case of no longer receiving feedback for a certain period of time after completing the previous data transmission or in the case of transmitting no data. In this method, the preconfigured PDSCH may be transmitted every N slots or ms, and N may be set as the difference between the current time and the last data transmission time.

The method of configuring a specific RB for the preconfigured PDSCH may correspond to a method of configuring the specific RB as an RB for the preconfigured PDSCH according to an embodiment of the disclosure and transmitting the preconfigured PDSCH when the RB is empty, i.e., not allocated to a PDSCH for other existing data transmission, or becomes a surplus RB or a spare RB. Alternatively, the RB for the preconfigured PDSCH may be configured so that the RB can always be used only for the preconfigured PDSCH transmission.

The transmission method based on PRB utilization may correspond to a method of preconfiguring a PRB utilization rate and transmitting the preconfigured PDSCH related to an embodiment when the PRB utilization rate is lower than a preconfigured value (threshold).

The transmission method according to the scheduling frequency may correspond to a method of transmitting the preconfigured PDSCH related to an embodiment according to the difference in PRB allocated to each UE or the scheduling frequency. This may correspond to a method of adjusting and transmitting the preconfigured PDSCH for each UE, and may correspond to a method for securing an equal amount of data for each UE when the base station secures the necessary data.

The transmission method based on a request from the UE or the base station may correspond to a method in which the UE or base station makes a request as needed and the preconfigured PDSCH related to an embodiment is transmitted when such a request is made. This method may be used together with another transmission method.

According to embodiments, one or any combination of the above-described transmission methods of the preconfigured PDSCH may be applied and used.

According to an embodiment, IP throughput can be maximized when using the preconfigured PDSCH for AI communication support and fast link adaptation, and the estimation equation for IP throughput can be determined by spectral efficiency (SE) and available RB (total RB minus used RB) as follows.

$$IP {Tput}_{Est} ≅ SE * ( {RB}_{total} - UsedRB ) .$$

Referring to the above equation, when the preconfigured PDSCH is used, the number of available RBs may gradually decrease, and in this case, SEs sufficient to overcome this may be required. In other words, when the preconfigured PDSCH is used, side effects such as energy consumption, an interference problem, or a reduction in available RBs may occur.

According to an embodiment, the energy consumption due to the use of the preconfigured PDSCH is an additional energy consumption that occurs when the base station additionally transmits a PDSCH and the UE additionally decodes the same. In this regard, a method may be considered that may reduce or compromise with the energy consumption by adjusting the amount of preconfigured PDSCH transmission through a periodic transmission method or linkage with CDRX technology. In addition, a method that does not consider retransmission for NACK feedback for the preconfigured PDSCH may be used, and also using the preconfigured PDSCH allows an appropriate MCS to be selected through rapid link adaptation, thereby reducing energy consumption.

According to an embodiment, for the interference problem as well due to the use of the preconfigured PDSCH, a method of reducing or compromising with interference by adjusting the amount of preconfigured PDSCH transmission through a periodic transmission method or linkage with CDRX technology may be considered. In an embodiment, the amount of interference may be adjusted by reducing the amount of preconfigured PDSCH transmission with PRB utilization value (threshold) adjusted. In an embodiment, in the case of configuring a specific RB for the preconfigured PDSCH, the interference may be concentrated on the specific RB, and in this case, interference estimation may be facilitated, so that decoding performance may be secured through a method such as selecting an appropriate receiver according to interference estimation.

According to an embodiment, regarding the reduction in available RBs, a PRB utilization value (threshold) may be adjusted to secure an appropriate amount of available RBs. In an embodiment, a method of not transmitting the preconfigured PDSCH when the PRB utilization value falls below a specific PRB utilization value may be considered.

Meanwhile, various DCI configurations for the preconfigured PDSCH according to an embodiment may be considered. In an embodiment, a DCI configuration may consider a method of using an existing DCI field or a new DCI field.

The base station may include, in the DCI, an indicator indicating that a PDSCH being transmitted to the UE is not a typical PDSCH for data transmission required by the UE, but the preconfigured PDSCH according to an embodiment. Specifically, since additional information may be required in the DCI to decode the preconfigured PDSCH, an indicator indicating that the current PDSCH is the preconfigured PDSCH may be included. For example, if the indicator is 1, the UE may identify that the decoded PDSCH is not a PDSCH for data transmission, but a PDSCH for AI communication function, model support, or link adaptation. In addition, according to an embodiment, the preconfigured PDSCH may have a plurality of roles, and the number of bits may be adjusted according to the roles. For example, if three roles for AI-related data collection, related result value check, and fast link adaptation can be considered, 2 bits may be used. Accordingly, if more roles are considered, a higher number of bits may be considered.

According to an embodiment, if needed, the DCI may include information indicating whether retransmission may be performed for the preconfigured PDSCH, information indicating whether HARQ feedback may be provided, or information indicating whether a DRX inactivity timer may be activated. Such information may be configured via an indicator.

For example, if an indicator indicating retransmission for the preconfigured PDSCH is 0, the base station may not perform retransmission even if the UE fails to decode the preconfigured PDSCH and transmits NACK. In addition, since the UE does not need an RV for the preconfigured PDSCH, the DCI may not include the RV.

For example, if an indicator indicating whether to provide HARQ feedback for the preconfigured PDSCH is 0, the UE may not transmit ACK/NACK regardless of the decoding result. This may be the case when the UE needs AI communication or model-related data.

For example, if an indicator indicating whether to activate the DRX inactivity timer is 0, the inactivity timer may not be activated even if the preconfigured PDSCH is received during the OnDurationTimer.

According to an embodiment, a case of acquiring necessary data for supporting an AI model (e.g., model inference check) by using one preconfigured PDSCH and a case of acquiring necessary data by using multiple preconfigured PDSCHs may be considered.

In the case of using one preconfigured PDSCH, one DCI may include information for one preconfigured PDSCH and may include the above-described indicators. The PDSCH sequence may include information related to the ID of the AI communication function, information related to the inference tuning value, information about the inference result and performance, etc. In addition, since several candidate models may be different and the characteristics of the learning data applied to each model may be different, the ID of the AI candidate model (e.g., the ID of the bandit) may be included.

In the case of using multiple preconfigured PDSCHs, one DCI may include information for multiple preconfigured PDSCHs. In this case, the DCI may additionally include an indicator indicating whether to transmit multiple preconfigured PDSCHs, the number of preconfigured PDSCHs linked to the DCI, preconfigured PDSCH offset information, etc. For example, when the indicator indicating whether to transmit multiple preconfigured PDSCHs is 1, multiple preconfigured PDSCHs can be decoded through one DCI. In addition, through information on the number of preconfigured PDSCHs linked to the DCI and information on the offset, it is possible to identify the number of preconfigured PDSCHs, and the offset on the time-frequency domains between multiple preconfigured PDSCHs linked to one DCI. In addition, the information on the number of preconfigured PDSCHs linked to the DCI may mean the number of candidate models (bandits) for which a result is to be checked or the number of risk management policies.

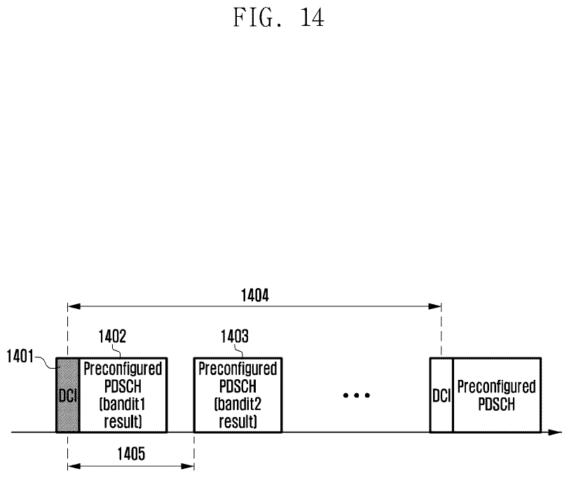

FIG. 14 illustrates an example of checking results for multiple AI candidate models (bandits), according to an embodiment of the disclosure.

According to FIG. 14, an example of transmitting multiple preconfigured PDSCHs based on one DCI 1401 is shown.

Using multiple preconfigured PDSCHs, various ACK/NACK feedback for the results of multiple AI candidate models can be obtained, and related information for the best selection in a multi-armed bandit can also be obtained.

In FIG. 14, 1404 corresponds to a period between transmission sets of multiple preconfigured PDSCHs based on one DCI, and 1405 corresponds to an offset value related to a DCI 1401 and a preconfigured PDSCH 1403.

In this case, a sequence of preconfigured PDSCHs 1402 and 1403 may include at least one of information or ID that may indicate the type of AI communication function, ID of AI candidate model (bandit), inference tuning value, inference result, and performance.

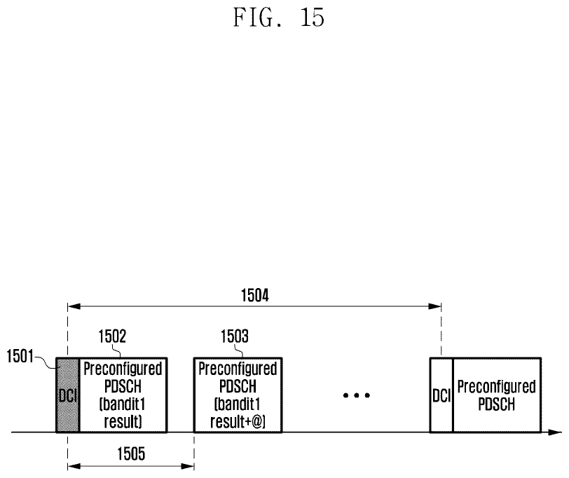

FIG. 15 illustrates an example of checking results for multiple tuning values, according to an embodiment of the disclosure.

According to FIG. 15, an example of transmitting multiple preconfigured PDSCHs 1502 and 1503 based on one DCI 1501 is shown.

In FIG. 15, 1504 corresponds to a period between transmission sets of multiple preconfigured PDSCHs based on one DCI, and 1505 corresponds to an offset value related to a DCI 1501 and a preconfigured PDSCH 1503.

Using multiple preconfigured PDSCHs, various ACK/NACK feedback can be obtained for the results of a tuning technique for one AI model or link adaptation (e.g., a classification threshold exemplified as a threshold value used when predicting a class in a classification model, a risk averse method exemplified as a method for minimizing risks that may occur in a decision or prediction, a sampling method exemplified as a method for extracting samples to train a model or check results, an OLLA offset, etc.). In addition, in this case, an offset for the inference result can be included in the DCI.

In this case, a sequence of preconfigured PDSCHs 1502 and 1503 may include at least one of information or ID that may indicate the type of AI communication function, ID of the selected AI candidate model (bandit), inference tuning value, policy ID, inference result, and performance. In addition, the preconfigured PDSCH (1502, 1503) may include information on correction values for AI results and policies related to AI result inference. For example, in the case of IQN, the final MCS selection may differ depending on whether a more aggressive threshold is selected (risk-seeking) or a conservative threshold is selected (risk-averse) for the derived AI results.

According to FIG. 15, for example, a policy of increasing SINR by 0.1 dB or a policy of increasing SINR by 0.3 dB may be applied when increasing the OLLA offset. In addition, information about the inference result offset may be added to the DCI 1501.

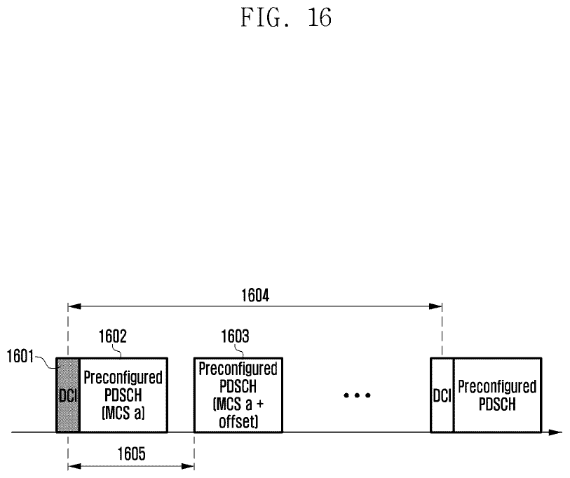

FIG. 16 illustrates an example of performing link adaptation using a preconfigured PDSCH, according to an embodiment of the disclosure.

According to FIG. 16, 1604 corresponds to a period between transmission sets of multiple preconfigured PDSCHs based on one DCI, and 1605 corresponds to an offset value related to a DCI 1601 and a preconfigured PDSCH 1603.

According to an embodiment, it is possible to consider a case of acquiring data to support link adaptation, etc. by using one preconfigured PDSCH and a case of acquiring data by using multiple preconfigured PDSCHs.

In the case of using one preconfigured PDSCH for link adaptation, one DCI may include information for one preconfigured PDSCH and may include the above-described indicators.

In the case of using multiple preconfigured PDSCHs for link adaptation, one DCI may include information for multiple preconfigured PDSCHs. In this case, the DCI may further include an indicator indicating whether to transmit multiple preconfigured PDSCHs, the number of preconfigured PDSCHs linked to the DCI, preconfigured PDSCH offset, MCS offset information, or the like. For example, when the indicator indicating whether to transmit multiple preconfigured PDSCHs is 1, multiple preconfigured PDSCHs can be decoded through one DCI. In addition, through information on the number of preconfigured PDSCHs linked to the DCI and information on the offset, it is possible to identify the number of preconfigured PDSCHs, and the offset on the time-frequency domains between multiple preconfigured PDSCHs linked to one DCI. The MCS offset information may correspond to offset information related to MCS (e.g., an offset for an MCS index, an offset for an estimated SINR, etc.).

According to FIG. 16, an example of transmitting multiple preconfigured PDSCHs 1602 and 1603 based on one DCI 1601 is shown, and the preconfigured PDSCHs 1602 and 1603 can be transmitted by the same or different MCS.

According to an embodiment, the preconfigured PDSCH can be transmitted by reusing the existing DCI field or IE. The existing field may correspond to K0 related to PDCCH and PDSCH interval, K1 related to HARQ feedback time, SLIV related to start symbol scheduled in a specific slot of PDSCH, frequency domain resource allocation (FDRA), MCS level, etc.

According to an embodiment, by transmitting a plurality of preconfigured PDSCHs, it is possible to variously obtain feedback (e.g., ACK/NACK feedback) for MCS.

For example, by transmitting all of a preconfigured PDSCH 1602, a preconfigured PDSCH 1603, etc. with MCS a as a method of transmitting a plurality of preconfigured PDSCHs for the same MCS, it is possible to obtain feedback.

For example, by transmitting a preconfigured PDSCH 1602, a preconfigured PDSCH 1603, etc. with MCS b, MCS b+1, etc., respectively, as a method of transmitting a plurality of preconfigured PDSCHs for different MCSs, it is possible to obtain feedback.

According to an embodiment, the DCI 1601 may include an indicator indicating whether multiple preconfigured PDSCHs are transmitted, and may include an indicator indicating the number of the multiple preconfigured PDSCHs (e.g., the number of preconfigured PDSCHs 1602, 1603, etc.) In addition, the DCI may include offset information (on the time-frequency domains) between multiple preconfigured PDSCHs associated with one DCI. In addition, the DCI may include offset information related to MCS (e.g., an offset for an MCS index, an offset for an estimated SINR, etc.).

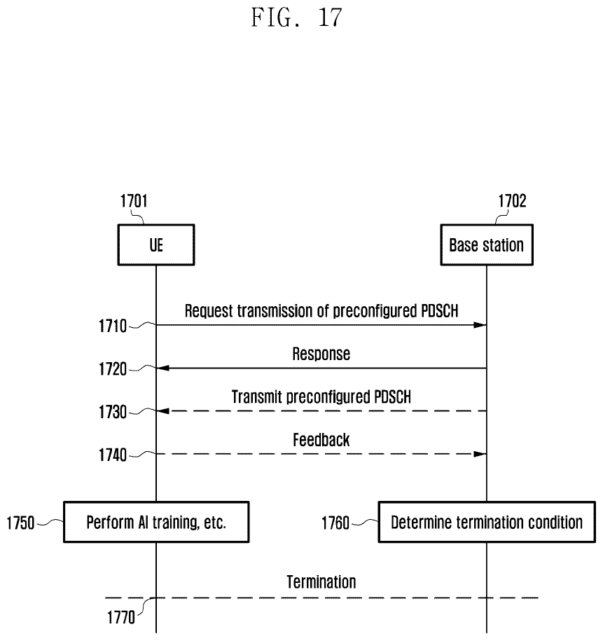

FIG. 17 illustrates a process in which a UE requests and receives a preconfigured PDSCH to support an AI model from a base station in an environment in which a model related to AI communication exists in the UE according to an embodiment of the disclosure.

According to FIG. 17, in step 1710, the UE 1701 may send a request (or request message) for a preconfigured PDSCH to the base station 1702 for supporting an AI communication related model, AI communication-related functions, learning for features, checking inference results, etc. Not limited to the above purpose, the UE 1701 may make a request for a preconfigured PDSCH to the base station 1702 for other specific purposes (e.g., checking functions other than AI, receiving additional data, etc.).

According to an embodiment, in step 1710, the request message of the UE 1701 may include information related to a termination condition of preconfigured PDSCH transmission such as information related to the amount of preconfigured PDSCH transmission, information related to a transmission time, an AI model training time, etc.

For example, the request message of the UE 1701 may include information on whether to transmit HARQ feedback for a preconfigured PDSCH, information on a threshold related to HARQ feedback transmission, information on a threshold related to the amount of preconfigured PDSCH transmission, information on a time or period for preconfigured PDSCH transmission, etc. In a certain case, the request message may be transmitted without including the transmission termination condition.

In step 1720, the base station 1702 can transmit, in response to step 1710, a response message to the UE 1701 including information on how to transmit the preconfigured PDSCH (e.g., a periodic transmission method, etc.). Alternatively, if the transmission method is preconfigured, the above information may not be included, and information required by the UE for receiving the preconfigured PDSCH may be added in addition to the above information.

In step 1730, the base station 1702 can transmit the preconfigured PDSCH to the UE 1701. The above-described embodiment of the disclosure related to a preconfigured PDSCH transmission method and a DCI transmission method can be applied to step 1730.

In step 1740, the UE 1701 can transmit feedback information (e.g., HARQ feedback) for the preconfigured PDSCH to the base station 1702. Depending on the configuration of the UE 1701, step 1740 may be omitted.

In step 1750, the UE 1701 can perform AI training, AI-related data collection or data collection for a specific purpose, AI inference support and check, etc. based on the received preconfigured PDSCH.

In step 1760, the base station 1702 can perform a process of determining whether the preconfigured PDSCH transmission termination condition received from the UE 1701 is satisfied.

In step 1770, the transmission of the preconfigured PDSCH can be terminated based on a stop request from the UE 1701 or a condition determination by the base station 1702.

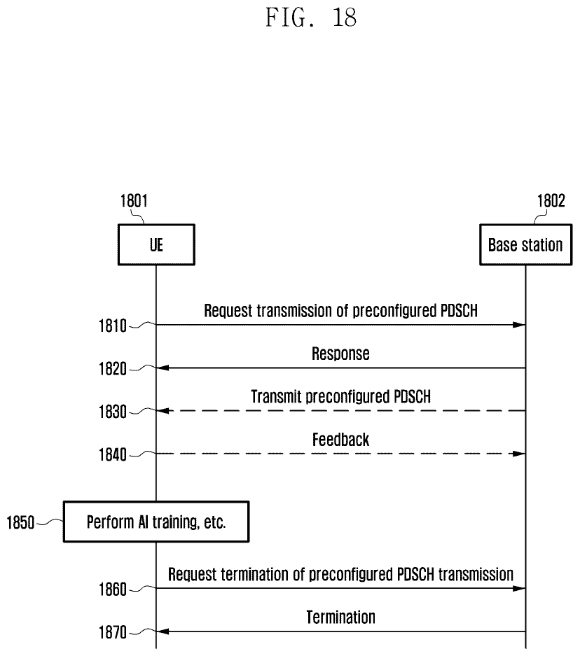

FIG. 18 illustrates a process in which a UE requests and receives a preconfigured PDSCH to support an AI model from a base station in an environment in which a model related to AI communication exists in the UE according to an embodiment of the disclosure.

According to FIG. 18, the UE 1801 can request only the start of preconfigured PDSCH transmission to the base station 1802. In this case, as needed, the UE 1801 can request the termination of preconfigured PDSCH transmission to the base station 1802.

For example, the UE 1801 may request the termination of preconfigured PDSCH transmission to the base station 1802 based on the UE's judgment, such as completion of learning related to the AI function or feature or power shortage.

In step 1810, the UE 1801 can request the base station 1802 to start the transmission of a preconfigured PDSCH.

In step 1820, the base station 1802 can transmit, in response to step 1810, a response message to the UE 1801 including information on how to transmit the preconfigured PDSCH (e.g., a periodic transmission method, etc.). Alternatively, if the transmission method is preconfigured, the above information may not be included, and information required by the UE for receiving the preconfigured PDSCH may be added in addition to the above information.

In step 1830, the base station 1802 can transmit the preconfigured PDSCH to the UE 1801. The above-described embodiment of the disclosure related to a preconfigured PDSCH transmission method and a DCI transmission method can be applied to step 1830.

In step 1840, the UE 1801 can transmit feedback information (e.g., HARQ feedback) for the preconfigured PDSCH to the base station 1802. Depending on the configuration of the UE 1801, step 1840 may be omitted.

In step 1850, the UE 1801 can perform AI training, AI-related data collection or data collection for a specific purpose, AI inference support and check, etc. based on the received preconfigured PDSCH.

In step 1860, the UE 1801 can, at its own discretion, request the base station 1802 to terminate the transmission of the preconfigured PDSCH.

In step 1870, the base station 1802 can terminate the transmission of the preconfigured PDSCH and transmit a response to the transmission termination request to the UE 1801.

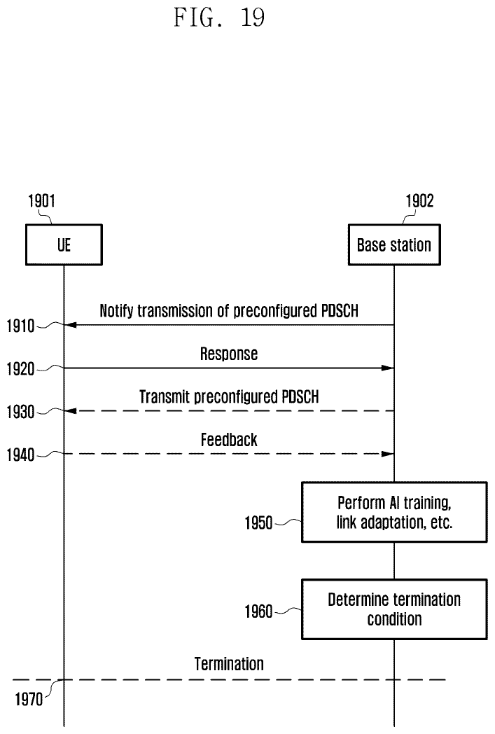

FIG. 19 illustrates a process in which a base station transmits a preconfigured PDSCH to a UE in an environment or link application in which a model related to AI communication exists in the base station according to an embodiment of the disclosure.

In step 1910, the base station 1902 can transmit a message to the UE 1901 to notify transmission of a preconfigured PDSCH for supporting an AI communication related model, AI communication-related functions, supporting AI-related link adaptation, learning for related functions or features, checking inference results, etc. Not limited to the above purpose, other purposes such as channel measurement for link adaptation, data collection for support for other technologies, evaluation of specific channel characteristics, etc. may be included.

In step 1910, the base station 1902 may transmit the message to the UE 1901 including information on how to transmit the preconfigured PDSCH (e.g., periodic transmission method, transmission time, period, information on separately configured RB, etc.). Alternatively, if the transmission method is preconfigured, the above information may not be included, and information required by the UE 1901 for receiving the preconfigured PDSCH may be added in addition to the above information.

According to an embodiment, the base station 1902 may include a condition related to the termination of preconfigured PDSCH transmission in the message notifying the preconfigured PDSCH transmission to the UE 1901. For example, the message may include information related to a termination condition of preconfigured PDSCH transmission such as information related to the amount of preconfigured PDSCH transmission, information related to a transmission time, information on the amount of HARQ feedback reception, etc. Alternatively, the message may be transmitted without including the termination condition.

In step 1920, the UE 1901 can transmit a response message to the message received in step 1910 to the base station 1902.

In step 1930, the base station 1902 can transmit the preconfigured PDSCH to the UE 1901. The above-described embodiment of the disclosure related to a preconfigured PDSCH transmission method and a DCI transmission method can be applied to step 1930.

In step 1940, the UE 1901 can transmit feedback information (e.g., HARQ feedback) for the preconfigured PDSCH to the base station 1902.

In step 1950, the base station 1902 can perform AI training, related data collection or data collection for a specific purpose, AI inference support and model check, link adaptation, etc. based on the received feedback information.

In step 1960, the base station 1902 can perform a process of determining whether the preconfigured PDSCH transmission termination condition is satisfied.

In step 1970, the transmission of the preconfigured PDSCH can be terminated based on a condition determination by the base station 1902.

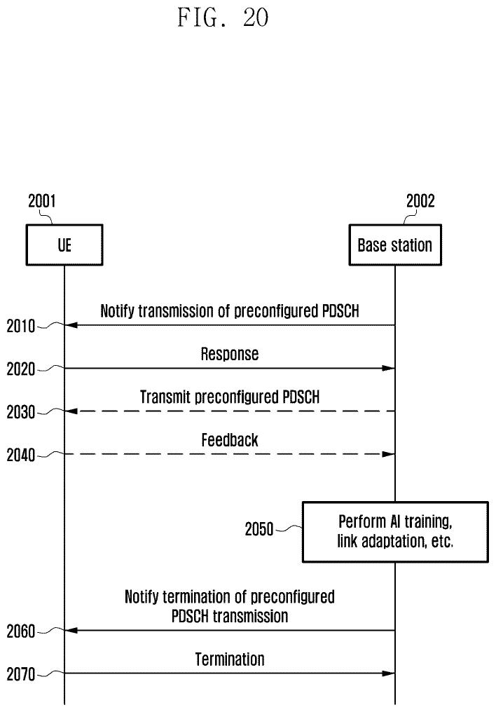

FIG. 20 illustrates a process in which a base station transmits a preconfigured PDSCH to a UE in an environment or link application in which a model related to AI communication exists in the base station, according to an embodiment of the disclosure.

According to FIG. 20, the base station 2002 can only notify the UE 2001 of the preconfigured PDSCH transmission without information on a condition related to the termination of transmission. In this case, as needed, the base station 2002 may transmit a message notifying the termination of preconfigured PDSCH transmission to the UE 2001.

For example, if the base station 2002 determines that learning related to the AI function or AI feature is completed, that sufficient data is secured, or that preconfigured PDSCH transmission is to be stopped due to other reasons such as a power problem, the base station 2002 may transmit the message notifying the termination of preconfigured PDSCH transmission to the UE 2001.

In step 2010, the base station 2002 may transmit a message notifying the preconfigured PDSCH transmission to the UE 2001 without information on the condition for the termination of transmission.

According to an embodiment, the base station 2002 may transmit the message to the UE 2001 including information on how to transmit the preconfigured PDSCH (e.g., periodic transmission method, transmission time, period, information on separately configured RB, etc.). Alternatively, if the transmission method is preconfigured, the above information may not be included, and information required by the UE 2001 for receiving the preconfigured PDSCH may be added in addition to the above information.

In step 2020, the UE 2001 can transmit a response message to the message received in step 2010 to the base station 2002.

In step 2030, the base station 2002 can transmit the preconfigured PDSCH to the UE 2001. The above-described embodiment of the disclosure related to a preconfigured PDSCH transmission method and a DCI transmission method can be applied to step 2030.

In step 2040, the UE 2001 can transmit feedback information (e.g., HARQ feedback) for the preconfigured PDSCH to the base station 2002.

In step 2050, the base station 2002 can perform AI training, related data collection or data collection for a specific purpose, AI inference support and model check, link adaptation, etc. based on the received feedback information.

In step 2060, the base station 2002 can determine the termination of PDSCH transmission as needed and transmit a message notifying the termination of the preconfigured PDSCH transmission to the UE 2001.

In step 2070, the UE 2001 can transmit a response to the message notifying the termination of the preconfigured PDSCH transmission to the base station 2002.

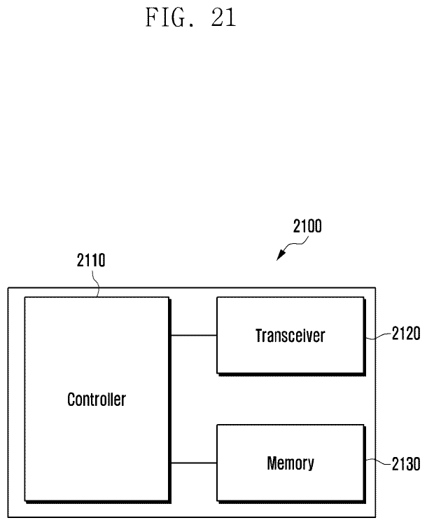

FIG. 21 illustrates an example of a structure of a UE according to an embodiment of the disclosure.

With reference to FIG. 21, the UE 2100 according to an embodiment of the disclosure may be configured to include a controller 2110, a transceiver 2120, and a memory 2130. In the disclosure, the controller 2110 of the UE 2100 may be defined as a circuit or an application-specific integrated circuit or at least one processor.

The controller 2110 can control the overall operation of the UE 2100 according to an embodiment of the disclosure. For example, the controller 2110 may control a signal flow between respective blocks to perform the above-described operations according to the drawing (or flowchart).

The transceiver 2120 can transmit and receive signals. For example, the transceiver 2120 may transmit signals to a node or a base station according to an embodiment of the disclosure, and receive signals from the node or the base station.

The memory 2130 can store at least one of information transmitted and received through the transceiver 2120 and information generated through the controller 2110. In addition, the memory 2130 may be defined as a storage.

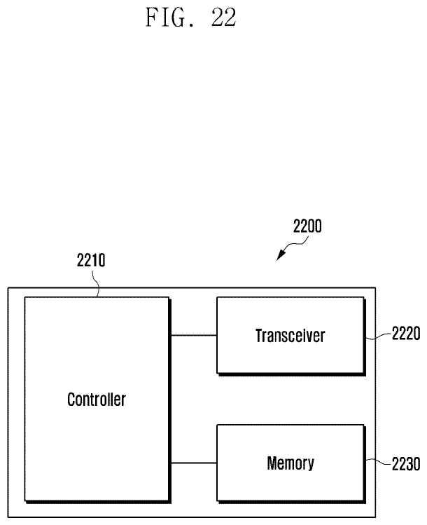

FIG. 22 illustrates an example of a structure of a base station according to an embodiment of the disclosure.

With reference to FIG. 22, the base station 2200 according to an embodiment of the disclosure may be configured to include a controller 2210, a transceiver 2220, and a memory 2230. In the disclosure, the controller 2210 of the base station 2200 may be defined as a circuit or an application-specific integrated circuit or at least one processor.

The controller 2210 can control the overall operation of the base station 2200 according to an embodiment of the disclosure. For example, the controller 2210 may control a signal flow between respective blocks to perform the above-described operations according to the drawing (or flowchart).

The transceiver 2220 can transmit and receive signals. For example, the transceiver 2220 may transmit signals to a UE or a node according to an embodiment of the disclosure, and receive signals from the UE or the node.

The memory 2230 can store at least one of information transmitted and received through the transceiver 2220 and information generated through the controller 2210. In addition, the memory 2230 may be defined as a storage.

The methods according to embodiments described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port.

Further, a separate storage device on the communication network may access a portable electronic device.

In the above-described detailed embodiments, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments described herein are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented.

Further, the above respective embodiments may be employed in combination, as necessary.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

Meanwhile, the embodiments of the disclosure described or illustrated herein are merely provided as specific examples to easily explain the technical content of the disclosure and help understand the disclosure, and are not intended to limit the scope of the disclosure. That is, it is apparent to a person skilled in the art that other modified examples based on the subject matter of the disclosure are possible. In addition, as needed, the above-described embodiments can be combined totally or at least in part.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a first message comprising first information for receiving a preconfigured physical downlink shared channel (PDSCH);
based on the first information, receiving, from the base station, the preconfigured PDSCH;
decoding on the received preconfigured PDSCH; and
transmitting, to the base station, second information on a result of the decoding,
wherein the preconfigured PDSCH is used to collect third information for improving a quality of data transmission or reception, and
wherein the preconfigured PDSCH is received based on a time when a PDSCH for data reception is not received.

2. The method of claim 1, further comprising:
transmitting, to the base station, a second message requesting the preconfigured PDSCH,
wherein the second message comprises a condition associated with a reception of the preconfigured PDSCH.

3. The method of claim 1, wherein the first information comprises at least one of an indicator indicating that the preconfigured PDSCH is used to collect the third information or an indicator associated with the preconfigured PDSCH.

4. The method of claim 1, wherein the first information comprises at least one of an indicator indicating whether to retransmit the preconfigured PDSCH, an indicator associated with a hybrid automatic repeat request (HARQ), or an indicator indicating that a discontinuous reception (DRX) inactivity timer is not activated while the preconfigured PDSCH is received.

5. The method of claim 1, further comprising receiving the preconfigured PDSCH based on at least one of a specific cycle, on a specific resource block (RB) where the PDSCH for a data reception is not allocated, or a pre-configured reference value,
wherein:
the preconfigured PDSCH comprises the third information,
the decoding is performed on the preconfigured PDSCH,
the second information is used for a communication system using an artificial intelligence (AI) model or a link adaptation, and
the link adaptation determines a modulation coding scheme (MCS) based on the second information.

6. A method performed by a base station in a wireless communication system, the method comprising:
transmitting, to a terminal, a first message comprising first information for transmitting a preconfigured physical downlink shared channel (PDSCH);
transmitting, to the terminal, the preconfigured PDSCH; and
receiving, from the terminal, second information based on a result of decoding on the preconfigured PDSCH,
wherein the preconfigured PDSCH is used to collect third information for improving a quality of data transmission or reception, and
wherein the preconfigured PDSCH is transmitted based on a time when a PDSCH for data transmission is not transmitted.

7. The method of claim 6, further comprising:
transmitting, to the terminal, a message notifying a transmission of the preconfigured PDSCH,
wherein the message comprises a condition associated with the transmission of the preconfigured PDSCH.

8. The method of claim 6, wherein the first information comprises at least one of an indicator indicating that the preconfigured PDSCH is used to collect the third information or an indicator associated with the preconfigured PDSCH.

9. The method of claim 6, wherein the first information comprises at least one of an indicator indicating whether to retransmit the preconfigured PDSCH, an indicator associated with a hybrid automatic repeat request (HARQ), or an indicator indicating that a discontinuous reception (DRX) inactivity timer is not activated while the preconfigured PDSCH is received.

10. The method of claim 6, further comprising transmitting the preconfigured PDSCH based on at least one of a specific cycle, a specific resource block (RB) where the PDSCH for a data transmission is not allocated, or a pre-configured reference value,
wherein:
the preconfigured PDSCH comprises the third information,
the second information is used for a communication system using an artificial intelligence (AI) model or a link adaptation, and
the link adaptation determines a modulation coding scheme (MCS) based on the second information.

11. A terminal in a wireless communication system, the terminal comprising:
a transceiver; and
at least one processor coupled with the transceiver and configured to:
receive, from a base station, a first message comprises first information for receiving a preconfigured physical downlink shared channel (PDSCH),
based on the first information, receive, from the base station, the preconfigured PDSCH,
perform decoding on the received preconfigured PDSCH, and
transmit, to the base station, second information on a result of the decoding,
wherein the preconfigured PDSCH is used to collect third information for improving a quality of data transmission or reception, and
wherein the at least one processor is further configured to receive the preconfigured PDSCH based on a time when a PDSCH for data reception is not received.

12. The terminal of claim 11, wherein the at least one processor is further configured to transmit, to the base station, a second message requesting the preconfigured PDSCH, and
wherein the second message comprises a condition associated with the preconfigured PDSCH.

13. The terminal of claim 11, wherein the first information comprises at least one of an indicator indicating that the preconfigured PDSCH is used to collect the third information or an indicator associated with the preconfigured PDSCH.

14. The terminal of claim 11, wherein the first information comprises at least one of an indicator indicating whether to retransmit the preconfigured PDSCH, an indicator associated with a hybrid automatic repeat request (HARQ), or an indicator indicating that a discontinuous reception (DRX) inactivity timer is not activated while the preconfigured PDSCH is received.

15. The terminal of claim 11, wherein:
the at least one processor is further configured to receive the preconfigured PDSCH based on at least one of a specific cycle, a specific resource block (RB) where the PDSCH for a data reception is not allocated, or a pre-configured reference value,
the preconfigured PDSCH comprises the third information,
the decoding is performed on the preconfigured PDSCH,
the second information is used for a communication system using an artificial intelligence (AI) model or a link adaptation, and
the link adaptation determines a modulation coding scheme (MCS) based on the second information.

16. A base station in a wireless communication system, the base station comprising:
a transceiver; and
at least one processor coupled with the transceiver and configured to:
transmit, to a terminal, a first message comprising first information for transmitting a preconfigured physical downlink shared channel (PDSCH),
transmit, to the terminal, the preconfigured PDSCH, and
receive, from the terminal, second information based on a result of decoding on the preconfigured PDSCH,
wherein the preconfigured PDSCH is used to collect third information for improving a quality of data transmission or reception, and
wherein the at least one processor is further configured to transmit the preconfigured PDSCH based on a time when a PDSCH for data transmission is not transmitted.

17. The base station of claim 16, wherein the at least one processor is configured to:
transmit, to the terminal, a message notifying a transmission of the preconfigured PDSCH, and
wherein the message comprises a condition associated with the transmission of the preconfigured PDSCH.

18. The base station of claim 16, wherein the first information comprises at least one of an indicator indicating that the preconfigured PDSCH is used to collect the third information or an indicator associated with the preconfigured PDSCH.

19. The base station of claim 16, wherein the first information comprises at least one of an indicator indicating whether to retransmit the preconfigured PDSCH, an indicator associated with a hybrid automatic repeat request (HARQ), or an indicator indicating that a discontinuous reception (DRX) inactivity timer is not activated while the preconfigured PDSCH is received.

20. The base station of claim 16, wherein:
the at least one processor is further configured to transmit the preconfigured PDSCH based on at least one of a specific cycle, a specific resource block (RB) where the PDSCH for a data reception is not allocated, or a pre-configured reference value;
the preconfigured PDSCH comprises the third information;
the second information is used for a communication system using an artificial intelligence (AI) model or a link adaptation; and
the link adaptation determines a modulation coding scheme (MCS) based on the second information.
